(19) United States
(12) Patent Application Publication
(10) Pub. No.: US 2024/0306057 A1
(43) Pub. Date: Sep. 12, 2024

(54) Determination of RLP Relaxation Factor and/or Signal Quality Threshold Based on RS Occasion Periodicity for Performing Relaxed RLP

(71) Applicant: Telefonaktiebolaget LM Ericsson (publ), Stockholm (SE)

(72) Inventors: Santhan Thangarasa, Vällingby (SE); Muhammad Ali Kazmi, Sundbyberg (SE); Kazuyoshi Uesaka, Kawasaki (JP); Ming Li, Stockholm (SE)

(21) Appl. No.: 18/272,232

(22) PCT Filed: Jan. 17, 2022
(86) PCT No.: PCT/EP2022/050897

§ 371 Date: Jul. 13, 2023

Related U.S. Application Data
(60) Provisional application No. 63/138,239, filed on Jan. 15, 2021.

(51) Int. Cl. H04W 36/00; H04W 24/08; H04W 76/28

(52) U.S. Cl. CPC H04W 36/0085; H04W 24/08; H04W 76/28

(57) ABSTRACT

A User Equipment (UE) in a wireless network, if in a permissible Operational Scenario (OS), performs Radio Link Procedures (RLP), such as Radio Link Monitoring (RLM) or Beam Management (BM) procedures, in a relaxed mode to preserve battery power. The UE may obtain a measurement relaxation factor K based on an effective Reference Signal (RS) occasion periodicity Te and uses K to perform RLP over an extended measurement or evaluation period (Tmr), which is obtained by scaling the legacy measurement period (Tm) by K. The UE may obtain an absolute or relative signal quality threshold S and use S to determine relaxed mode operation. The UE may obtain both K and S, and use both together. Permissible OS may include low UE mobility, low UE activity (e.g., DRX), and high signal quality.

This application claims priority to U.S. Provisional Patent Application Ser. No. 63/138,239, filed Jan. 15, 2021, the disclosure of which is incorporated herein by reference in its entirety.

### TECHNICAL FIELD

The present invention relates generally to wireless communication networks, and in particular to a system and method of adapting a Radio Link Procedure relaxation factor based on a Reference Signal occasion periodicity.

### BACKGROUND

Wireless communication networks, including network nodes and wireless devices such as cellphones and smartphones (also known as User Equipment, or UE), are ubiquitous in many parts of the world. These networks continue to grow in capacity and sophistication. To accommodate both more users and a wider range of types of devices that may benefit from wireless communications, the technical standards governing the operation of wireless communication networks continue to evolve. The fourth generation of network standards (4G, also known as Long Term Evolution, or LTE) has been deployed, the fifth generation (5G, also known as New Radio, or NR) is in development or early deployment, and the sixth generation (6G) is being planned.

The basic structure of 4G and 5G wireless networks is referred to as “cellular,” with (usually) fixed network nodes, referred to generically as “base stations,” providing wireless service to a large plurality of (usually) mobile UE within a geographic area, sometimes called a “cell.” FIG. 1 shows this basic network architecture in the case of 5G.

Wireless communication network 1 comprises a 5G Radio Access Network (RAN) 2 and a 5G Core (5GC) 3. The 5G RAN 2 comprises one or more base stations 4 providing service to UEs 5 in respective cells of the wireless communication network 1. The base stations 4 may comprises 5G NodeBs (gNBs) that implement the New Radio (NR) standard over the air interface, or Next Generation Evolved NodeBs (ng-eNBs) that implement the LTE standard, also known as Evolved Universal Terrestrial Radio Access (E-UTRA), over the air interface. The 5GC provides the UEs 5 with a connection to external packet data networks.

The UEs 5 may comprise any type of equipment capable of communicating with the base station 4 over a wireless communication channel. For example, the UEs 5 may comprise cellular telephones, smart phones, laptop computers, notebook computers, tablets, machine-to-machine (M2M) devices (also known as machine type communication (MTC) devices), embedded devices, wireless sensors, or other types of wireless end user devices capable of communicating over wireless communication networks 1.

A 5G network can be deployed with or without interworking with LTE as depicted in FIG. 2. In LTE, the base stations 4, referred to as Evolved NodeBs (eNBs) in a Evolved Universal Terrestrial Radio Access Network (E-UTRAN) connect to the Evolved Packet Core (EPC). In a stand-alone (SA) deployment, the NR and LTE networks are deployed without any interworking. In this case, the gNBs in the 5G-RAN 2 connect to the 5GC 3 and the eNBs in the E-UTRAN connect to EPC with no interconnection between the two. Options 1 and 2 in FIG. 2 illustrate SA deployments. Option 3 in FIG. 2 illustrates a deployment option called E-UTRAN-NR Dual Connectivity (EN-DC). In the EN-DC deployment, dual connectivity (DC) between NR and LTE is applied with LTE as the master and NR as the secondary node. The RAN node (gNB) supporting NR does not have a control plane connection to the EPC. Instead, the gNB relies on the LTE as master node (MeNB). This deployment is also called “Non-standalone NR.” Notice that in this case the functionality of an NR cell is limited and would be used for Connected mode as a booster and/or diversity leg, but a UE 5 in RRC_IDLE mode cannot camp on the NR cells.

With introduction of 5GC, other options are also possible. As mentioned above, Option 2 supports stand-alone NR deployment where gNB is connected to 5GC. Similarly, a ng-eNB base station 4 can also be connected to 5GC using Option 5 (also known as eLTE, E-UTRA/5GC, or LTE/5GC). In these cases, both NR and LTE are seen as part of the NG-RAN (and both the ng-eNB and the gNB can be referred to as NG-RAN nodes). It is worth noting that Options 4 and 7 are variants of dual connectivity between LTE and NR which will be standardized as part of NG-RAN connected to 5GC, denoted as Multi-Radio Dual Connectivity (MR-DC). Under the MR-DC umbrella, the following options are available:
Option 3 (EN-DC): LTE is the master node and NR is the secondary (EPC employed)
Option 4 (NE-DC): NR is the master node and LTE is the secondary (5GC employed)
Option 7 (NGEN-DC): LTE is the master node and NR is the secondary (5GCN employed)
Option 2 variant (NR-DC): Dual connectivity where both the master and secondary are NR (5GC employed).

In any of these configurations, UEs are periodically directed by the network to perform measurements of the air interface signal strength and channel quality, and to report the measurements to the network. This is done for Mobility Management and to put a UE with sufficiently poor channel quality Out Of Service (OOS). For example, UEs may be directed to measure Reference Signals (RS) transmitted not only by a serving base station, but additionally by neighboring base stations. When a neighbor base station's signals are stronger than the serving base station's (and additionally based on data such as tracking the UE's physical location and movement), the network will initiate a handover procedure, so that the UE is served by the nearest/strongest base station. These measurements are known as Radio Link Monitoring (RLM). RLM is a subset of procedures known more generally as Radio Link Procedures (RLP), as discussed further herein. As UEs move through the network, particularly at high speed, it is important that they perform RLM relatively often—that is, with a low periodicity.

### Radio Link Monitoring in NR

RLM evaluation in NR is performed based on up to 8 RLM reference signal (RLM-RS) resources configured by the network, where:
One RLM-RS resource can be either one Synchronization Signal/Physical Broadcast Channel (SS/PBCH) block or one Channel State Information RS (CSI-RS) resource/port,
The RLM-RS resources are UE-specifically configured.

According to 3GPP TS 38.133 V16.5.0, Radio link procedure is applicable for
Primary Cell (PCell) in SA NR, NR-DC and NE-DC operation mode,
Primary Secondary Cell (PSCell) in NR-DC and EN-DC operation mode.

SS/PBCH block further comprises channels/signals (e.g., Primary Sync Signal (PSS), Secondary Sync Signal (SSS), PBCH, Demodulation RS (DMRS) for PBCH, CSI-RS, etc.) periodically for UE to synchronize with the network and to acquire channel information. Such channels/signals are transmitted at the same transmission burst called discovery reference signals (DRS). DRS is transmitted by the base station periodically with certain periodicity e.g., 20 ms, 40 ms, 80 ms, 160 ms, etc. Each Synchronization Signal Block (SSB) or SSB-based measurement timing configuration (SMTC) occasion, which occurs periodically, contains one or more SSB/PBCH signals. SMTC contains, for example, SS/PBCH blocks (or SSB), CSI-RS, PDSCH for transmitting System Information Block 1 (SIB1). The UE is configured with information about SSB on cells of a carrier by SMTC, which comprises SMTC periodicity, SMTC occasion length in time or duration, SMTC time offset with respect to reference time (e.g., serving cell's System Frame Number, or SFN).

The UE is configured with one or more RLM-RS resources for each of which the UE shall estimate the downlink radio link quality (e.g., Signal to Noise Ratio (SNR), Signal to Interference and Noise Ratio (SINR), Received Signal Reference Power (RSRP)), and compare it to the thresholds Qₒᵤₜ and Qᵢₙ (derived based on a hypothetical Physical Downlink Control Channel (PDCCH) Block Error Rate (BLER) of 10%) for the purpose of monitoring downlink radio link quality of the cell. More specifically, the UE shall be able to evaluate whether the downlink radio link quality on the configured RLM-RS resource estimated over the last OOS evaluation period (T_{Evaluate_out}) becomes worse than the threshold Qₒᵤₜ within T_{Evaluate_out} evaluation period, and the UE shall be able to evaluate whether the downlink radio link quality on the configured RLM-RS resource estimated over the last IS evaluation period (T_{Evaluate_in}) becomes better than the threshold Qᵢₙ within T_{Evaluate_in} evaluation period.

In frequency range #2 (FR2) (millimeter-wave, e.g., for frequencies between 24 GHz and 52.6 GHz), the RLM evaluation period additionally applies receiver (Rx) beam sweeping factor, N, where it is assumed the UE tries to receive RLM-RS with different Rx beam configuration to measure the RLM-RS. Example of N is 8. This means OOS and IS evaluation periods in FR2 are N times longer than the corresponding OOS and IS evaluation periods in frequency range #1 (FR1) (e.g., frequencies between 400 MHz and 7 GHz).

### Beam Management in NR

Using highly directional antennas, beam-steering technology allows a transmitter to control the direction of a tightly-focused beam of Electro-Magnetic (EM) Radiation carrying the modulated information signal(s). Similarly, Rx beamforming controls the direction of enhanced sensitivity for receiving Radio Frequency (RF) signals. Beam management is a procedure to maintain the beam connection for transmission and reception. The beam management is also interchangeably known as link recovery procedure. The beam management broadly comprises one or more of beam-related procedures, e.g., beam establishment, beam failure recovery, and beam indication (or beam reporting).

Beam establishment is a procedure where the UE selects the best (strongest) beam when it connects to the network. In order to identify the beam, the base station (gNB) transmits different SS/PBCH block and/or CSI-RS per beam. The beam establishment is usually performed at the same time the UE performs the initial cell search. At the initial cell search, a UE searches for the strongest SS/PBCH block and identifies its location in the time domain, which corresponds to the beam ID. After the UE has found the beam, UE tries to connect to the network using this beam. While the UE connects to the network, it measures the downlink link quality of the connecting beam. If the link quality level below is a threshold, the UE triggers a beam failure and starts a beam recovery procedure.

Beam failure recovery is a procedure in which the UE updates to another beam in the same cell when the current beam becomes weak due to changing channel condition, e.g., UE location change or rotation. Beam indication is a procedure where UE reports the beam condition (e.g., received signal power on the beam) to the network as CSI reporting.

According to 3GPP TS38.133 V16.5.0, beam management procedure is applicable for:
PCell in SA, NR-DC, or NE-DC operation mode,
PSCell in NR-DC and EN-DC operation mode, or
SCell in carrier aggregation.

Beam recovery procedure is a procedure to recover a beam connection when the beam which a UE is monitoring becomes weak. The UE measures the channel quality of the periodic SS/PBCH block and/or CSI-RS resources (q0) in a serving cell. If the measured quality is below the threshold Qout_LR, corresponding to hypothetical PDCCH BLER of 10%, the UE physical layer indicates beam failure to the Media Access Control (MAC) layer. This event is called beam failure detection (BFD).

In FR2, the BFD evaluation period additionally applies an Rx beam sweeping factor, N, where it is assumed the UE attempts to receive RLM-RS with different Rx beam configurations to measure the BFD-RS. An example of N is 8. This means the BFD evaluation period in FR2 is N times longer than the BFD evaluation period in FR1.

After BFD, the UE searches for candidate beams from the configured CSI-RS and/or SS/PBCH block resources for candidate beam detection (q1) in the serving cell. The UE determines one of the beams in q1 whose L1-RSRP exceeds the threshold rsrp-Threshold which is signaled from the network. This procedure is called candidate beam detection (CBD).

After determining the new beam in PCell/PSCell, UE reports the selected beam with the random access procedure, where the UE transmits a random access preamble on the Physical Random Access Channel (PRACH) corresponding to the SS/PBCH block and/or CSI-RS resource. After determining the new beam in the SCell, the UE reports the selected beam with the Beam failure recovery (BFR) message in MAC Control Element (CE).

In FR2, the CBD evaluation period additionally applies an Rx beam sweeping factor, N, where it is assumed the UE tries to receive the CBD-RS with different Rx beam configurations to measure the CBD-RS. An example of N is 8. N is the scaling factor depending on the configured cells, similarly to the CBD evaluation in FR1. This means the CBD evaluation period in FR2 is N times longer than the CBD evaluation period in FR1.

### L1-RSRP/L1-SINR Reporting in NR

L1-RSRP reporting is a part of the CSI reporting procedure where the UE reports the received power of the configured number of beams. The network uses the information to determine which beam is to be used to transmit data (PDCCH or Physical Downlink Shared Channel, PDSCH). L1-RSRP reporting is configured as periodic, aperiodic, or semi-persistent. For the periodic reporting, the UE shall transmit L1-RSRP on the Physical Uplink Control Channel (PUCCH) according to the periodicity configured by the network. For the aperiodic L1-RSRP reporting, the UE shall transmit L1-RSRP on the Physical Uplink Shared Channel (PUSCH) after the UE receives a CSI request in Downlink Control Information (DCI). For the semi-persistent L1-RSRP reporting, the UE shall transmit L1-RSRP reporting on PUSCH or PUCCH according to the periodicity specified by the higher layer. For the semi-persistent reporting, the UE stops L1-RSRP reporting after the configured number of report transmissions. The reporting period is given by T_{Report}.

In FR2, the L1-RSRP measurement period additionally applies an Rx beam sweeping factor, N, where it is assumed the UE tries to receive SSB with different Rx beam configurations to measure the SSB. An example of N is 8. This means the L1-RSRP measurement period in FR2 is N times longer than the L1-RSRP measurement in FR1.

Similar to L1-RSRP reporting, L1-SINR reporting is also a part of the CSI reporting procedure where the UE reports the ratio of received power of the channel measurement resources (CMR) and received power of the interference measurement resource (IMR). 3GPP assumes CMR is SSB or CSI-RS, and IMR is Non-zero-power CSI-RS (NZP-CSI-RS) or zero-power CSI-RS (ZP-CSI-RS).

In FR2, the L1-SINR measurement period additionally applies an Rx beam sweeping factor, N, where it is assumed the UE tries to receive SSB and IMR with different Rx beam configurations to measure the SSB and IMR. An example of N is 8. This means the L1-SINR measurement period in FR2 is N times longer than the L1-SINR measurement in FR1.

Both L1-RSRP and L1-SINR reporting are part of beam indication or beam reporting.

Two of the fundamental procedures in Radio Resource Control (RRC) CONNECTED state to ensure that UE maintains reliable communication with the serving cell(s) are radio link monitoring (RLM) and beam management (BM), as described above.

Both RLM and BM procedures requires the UE to perform certain steps or activities periodically or at least with certain periodicity, e.g., every radio frame, every DRX cycle, or every BM/RLM-RS transmission periodicity. Examples of such activities are performing measurement, processing the measurement (e.g., comparing to thresholds), triggering events/indications, triggering new procedures based on the outcome of the evaluations, etc. Such frequent measurement and/or processing activities can significantly increase the UE power consumption. In low mobility or stationary scenario, the UE is expected to have limited or no mobility. In such scenarios the radio conditions experienced by the UE may not change very much over the time, and UE power consumption may be reduced by extending the evaluation time for the measurements. Such measurements are performed on the reference signals such as SSBs and CSI-RS and the periodicities of these reference signals are typically configured by the serving network node, and can vary from every 5 ms to every 160 ms. Currently, the relation between the reference signal availability and relaxed RLM/BM operation that depends on that reference signal is undefined. This may cause different UE behavior or implementations which may lead to UEs not fully utilizing UE power saving potential.

The Background section of this document is provided to place embodiments of the present invention in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to a first embodiment related to a wireless device (e.g., UE), the UE obtains information (e.g., determines based on pre-defined rule, receives from a network node, etc.) about a measurement relaxation factor (K) based on an effective reference signal occasion periodicity (Te) and uses K for operating one or more radio link procedures (RLPs) in relaxed mode, provided that the UE is operating in a certain operational scenario (OS) where the relaxed RLP operation is allowed. In relaxed mode the RLP is performed over an extended measurement or evaluation period (Tmr) which is obtained by scaling the legacy measurement period (Tm) by K, e.g., Tmr=K*Tm.

According to a second embodiment related to a wireless device (e.g., UE), the UE obtains information (e.g., determines based on pre-defined rule, receives from a network node, etc.) a signal quality threshold (S) based on an effective reference signal occasion periodicity (Te) and performs the RLP in relaxed mode based on S, provided that the UE is operating in a certain operational scenario (OS) in which the UE is allowed to operate one or more RLPs in relaxed mode. The threshold, S, can an absolute threshold (Sa) or it can be a relative threshold (Sr).

According to a third embodiment, the UE obtains information about K and S based on Te, and uses the obtained values of K and S for performing RLP in relaxed mode, provided that the UE is operating in a certain operational scenario (OS) in which the UE is allowed to operate one or more RLPs in relaxed mode.

In these embodiments, Te is based on, or is function of, one or more combinations of parameters, e.g., reference signal periodicity, UE activity level, measurement gap sharing factor, frequency characteristics of the carrier frequency of the operated cell, etc.

The operational scenario where the relaxation is allowed is characterized by one or more of:
Low mobility scenarios, (e.g., stationary UEs, UE speed below a certain threshold, Doppler frequency below a certain threshold) etc.
Low UE activity, e.g., DRX cycle configuration from which UE knows how frequently it is expected to be awake, how long it is expected to be awake and its active time etc.
Signal quality (Qm) estimated for RLP is above certain absolute threshold (Sa) and/or signal quality (Q) estimated for RLP compared to a reference signal quality (Qr) is above certain relative threshold (Sr)

Examples of RLPs comprise RLM related procedures, BM related procedures, etc. Examples of RLM related events comprise in-sync, out-of-sync, radio link failure, etc. Examples of BM related events comprise BFD, CBD, L1-RSRP measurement, L1-RSRP reporting, etc. The procedures may also be referred to as events, operations, tasks, etc.

One embodiment relates to a method of performing Radio Link Procedures (RLP), performed by a wireless device operative in a wireless communication network. Whether the wireless device is operating in an operational scenario for which relaxed RLP is allowed is determined. In response to determining relaxed RLP is allowed, at least one of a measurement relaxation factor K and a signal quality threshold S are determining based on an effective RS occasion periodicity Te; and at least one of the determined measurement relaxation factor K and signal quality threshold S are applied for performing the RLP.

Another embodiment relates to a method of serving a wireless device performing Radio Link Procedures (RLP), by a network node operative in a wireless communication network. The wireless device is configured with information related to at least one operational scenario for which relaxed RLP is allowed. The wireless device is provided at least one of a measurement relaxation factor K, a signal quality threshold S, a relation between K and an effective RS occasion periodicity Te, and a relation between S and an effective RS occasion periodicity Te.

Yet another embodiment relates to a wireless device operative in a wireless communication network. The wireless device includes communication circuitry and processing circuitry operatively connected to the communication circuitry. The processing circuitry is configured to determine whether the wireless device is operating in an operational scenario for which relaxed RLP is allowed. In response to determining relaxed RLP is allowed, the processing circuitry is configured to determine at least one of a measurement relaxation factor K and a signal quality threshold S based on an effective RS occasion periodicity Te; and apply at least one of the determined measurement relaxation factor K and signal quality threshold S for performing the RLP.

Still another embodiment relates to a network node operative in a wireless communication network. The network node includes communication circuitry and processing circuitry operatively connected to the communication circuitry. The processing circuitry is configured to configure the wireless device with information related to at least one operational scenario for which relaxed RLP is allowed, and provide the wireless device at least one of a measurement relaxation factor K, a signal quality threshold S, a relation between K and an effective RS occasion periodicity Te, and a relation between S and an effective RS occasion periodicity Te.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a diagram of a wireless communication network.

FIG. 2 depicts numerous options of interconnectivity between 4G and 5G networks.

FIG. 3 is a flow diagram of a method of performing Radio Link Procedures (RLP) by a wireless device in a wireless communication network.

FIG. 4 is a flow diagram of a method of serving a wireless device performing Radio Link Procedures (RLP), by a network node operative in a wireless communication network.

FIG. 5 is hardware block diagram of a wireless device.

FIG. 6 is a functional block diagram of a wireless device.

FIG. 7 is hardware block diagram of a network node.

FIG. 8 is a functional block diagram of a network node.

FIG. 9 is a block diagram of a network and some network components.

FIG. 10 is a block diagram of a User Equipment.

FIG. 11 is a schematic block diagram illustrating a virtualization environment.

FIG. 12 illustrates a telecommunication network connected via an intermediate network to a host computer.

FIG. 13 illustrates host computer communicating via a base station with a user equipment over a partially wireless connection.

FIG. 14 is a flowchart illustrating a host computer communicating with a UE in a communication system.

FIG. 15 is a flowchart illustrating a host computer communicating with a UE in a communication system.

FIG. 16 is a flowchart illustrating a UE communicating with a host computer in a communication system.

FIG. 17 is a flowchart illustrating communication between a base station and a host computer in a communication system.

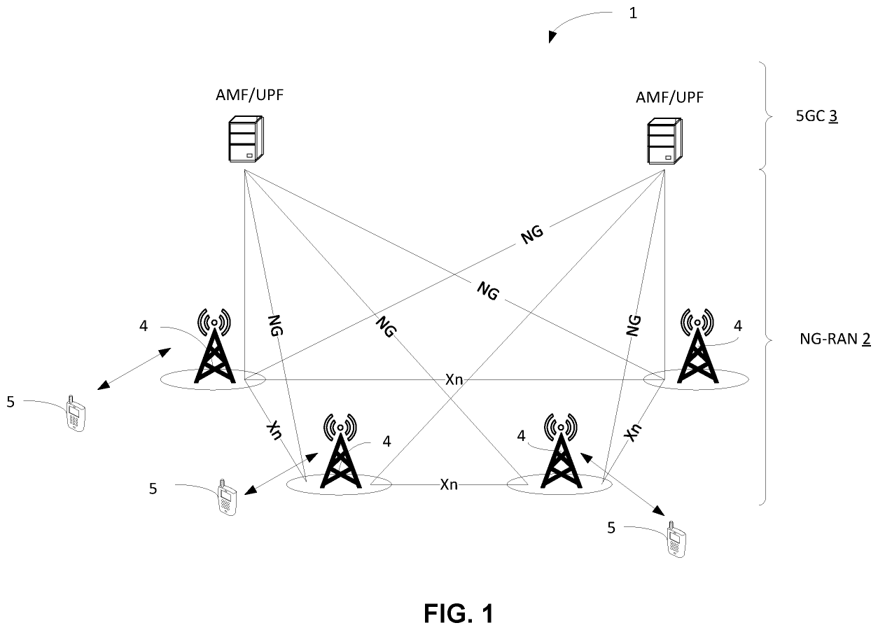

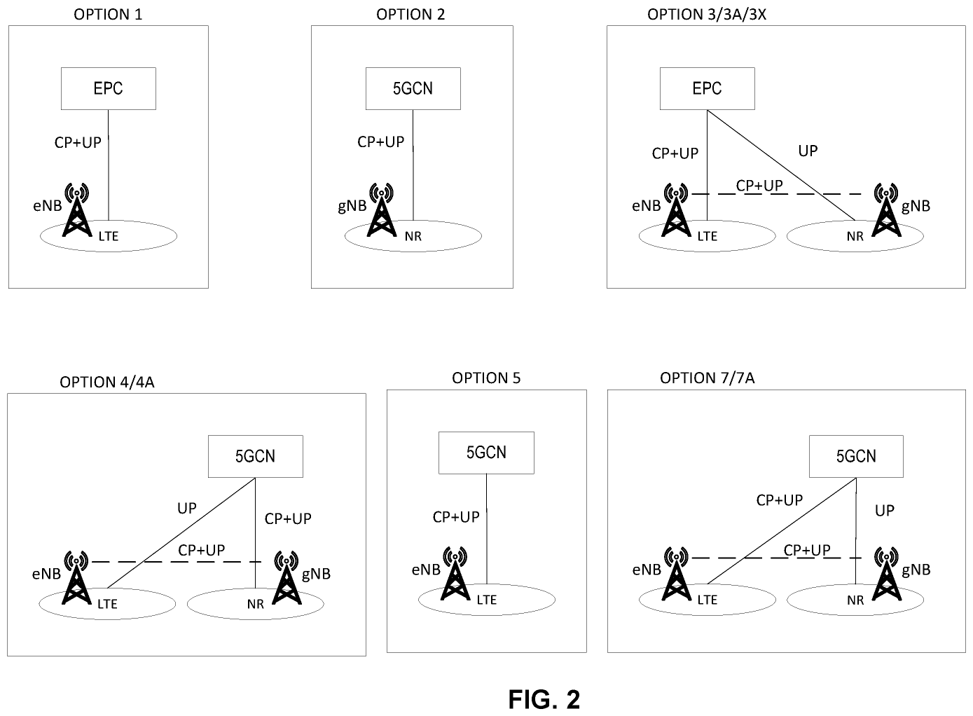

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

### Methods and Apparatuses

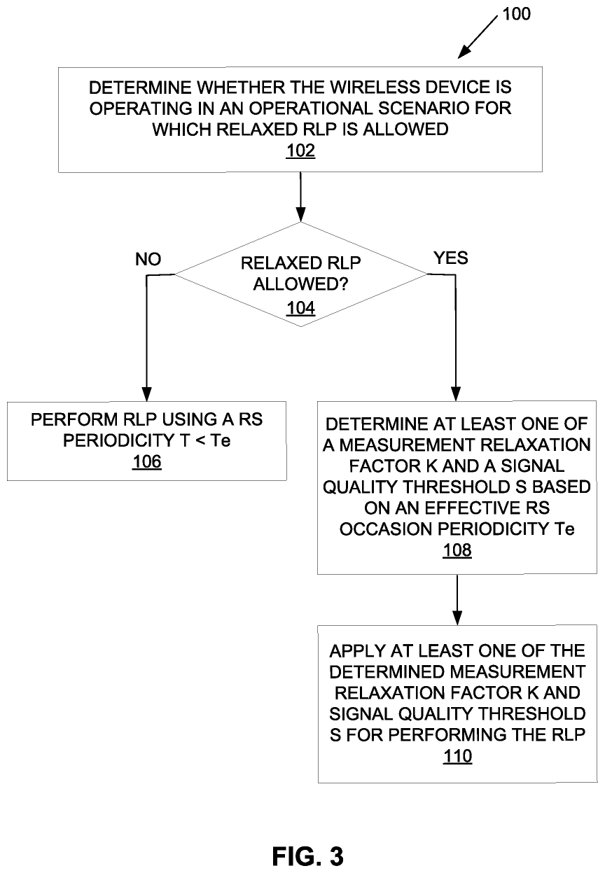

FIG. 3 depicts a method 100, in accordance with particular embodiments, of performing Radio Link Procedures (RLP) by a wireless device operative in a wireless communication network. The wireless device determines whether it is operating in an operational scenario for which relaxed RLP is allowed (block 102). In response to determining relaxed RLP is allowed (block 104), the wireless device determines at least one of a measurement relaxation factor K and a signal quality threshold S based on an effective RS occasion periodicity Te (block 108). The wireless device then applies at least one of the determined measurement relaxation factor K and signal quality threshold S for performing the RLP (block 110). In response to determining relaxed RLP is not allowed (block 104), the wireless device performs RLP over a measurement time Tm (block 106).

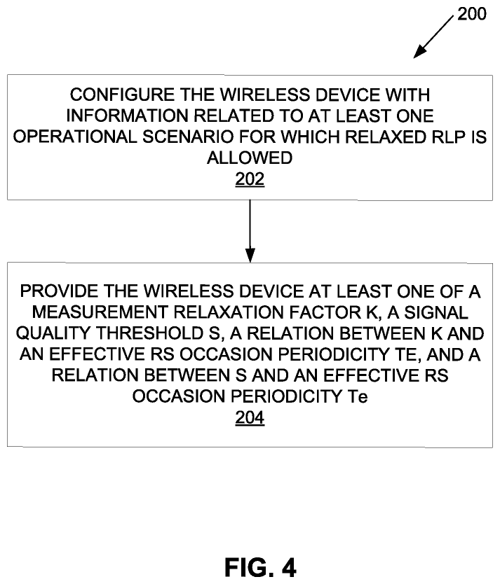

FIG. 4 depicts a method 200, in accordance with other particular embodiments, of serving a wireless device performing Radio Link Procedures (RLP) by a network node operative in a wireless communication network. The wireless device is configured with information related to at least one operational scenario for which relaxed RLP is allowed (block 202). The wireless device is provided at least one of a measurement relaxation factor K, a signal quality threshold S, a relation between K and an effective RS occasion periodicity Te, and a relation between S and an effective RS occasion periodicity Te (block 204).

Note that apparatuses described herein may perform the methods 100, 200 herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

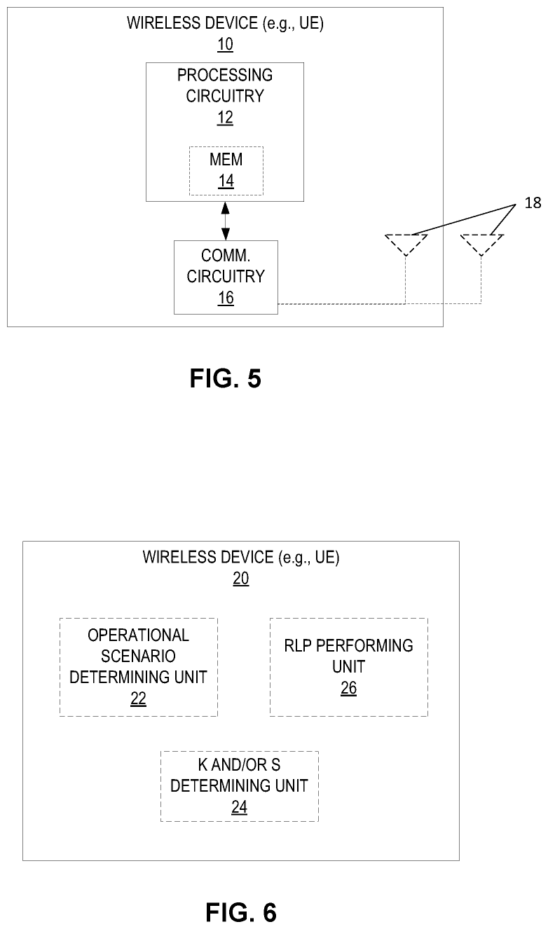

FIG. 5 for example illustrates a hardware block diagram of a wireless device 10 as implemented in accordance with one or more embodiments. As shown, the wireless device 10 includes processing circuitry 12 and communication circuitry 16. The communication circuitry 16 (e.g., radio circuitry) is configured to transmit and/or receive information to and/or from one or more other nodes, e.g., via any communication technology. Such communication may occur via one or more antennas 18 that are either internal or external to the wireless device 10, as indicated by dashed lines. The processing circuitry 12 is configured to perform processing described above, such as by executing instructions stored in memory 14, which may be internal, as shown, or may be external to the processing circuitry 12. The processing circuitry 12 in this regard may implement certain functional means, units, or modules.

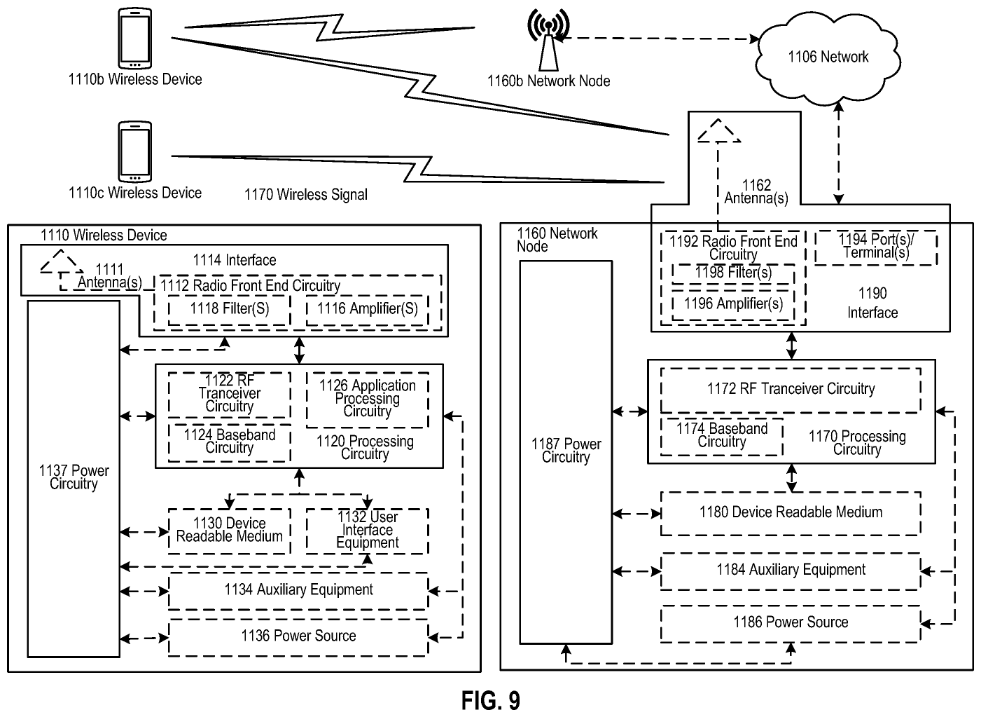

FIG. 6 illustrates a functional block diagram of a wireless device 20 in a wireless network according to still other embodiments (for example, the wireless network shown in FIG. 9). As shown, the wireless device 20 implements various functional means, units, or modules, e.g., via the processing circuitry 12 in FIG. 5 and/or via software code. These functional means, units, or modules, e.g., for implementing the method 100 herein, include for instance: operational scenario determining unit 22, RLP performing unit 24, and K and/or S determining unit 26.

Operational scenario determining unit 22 is configured to determine whether the wireless device is operating in an operational scenario for which relaxed RLP is allowed. In response to determining relaxed RLP is allowed, K and/or S determining unit 24 is configured to determine at least one of a measurement relaxation factor K and a signal quality threshold S based on an effective RS occasion periodicity Te. Also in response to determining relaxed RLP is allowed, RLP performing unit 26 is configured to apply at least one of the determined measurement relaxation factor K and signal quality threshold S for performing the RLP.

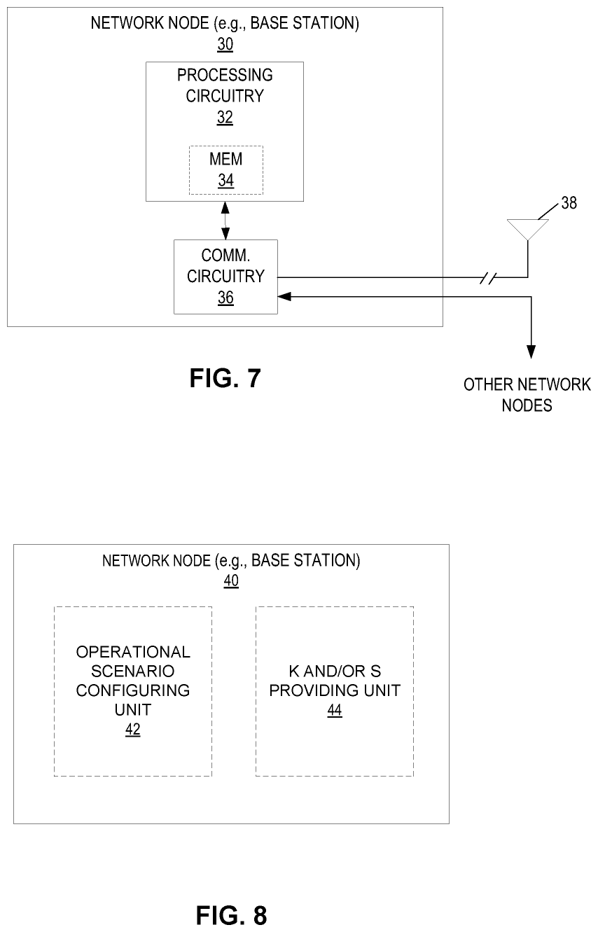

FIG. 7 illustrates a hardware block diagram of a network node 30 as implemented in accordance with one or more embodiments. The network node 30 may be a serving base station in a wireless communication network. As shown, the network node 30 includes processing circuitry 32 and communication circuitry 36. The communication circuitry 36 is configured to transmit and/or receive information to and/or from one or more other nodes, e.g., via any communication technology. The communication circuitry 36 further includes radio circuitry that is configured to transmit and/or receive information to and/or from one or more other nodes, e.g., via any communication technology. Such communication may occur via one or more antennas 38. As indicated by the broken line, the antennas 38 may be mounted remotely from the network node 30, such as on a building or tower. The processing circuitry 32 is configured to perform processing described above, such as by executing instructions stored in memory 34, which may be internal, as shown, or may be external to the processing circuitry 12. Those of skill in the art are aware of virtualization technology, whereby some or all processing nominally performed by the processing circuitry 12 may be executed remotely, such as at a data center in the so-called cloud. The processing circuitry 32 in this regard may implement certain functional means, units, or modules.

FIG. 8 illustrates a functional block diagram of a network node 40 in a wireless network according to still other embodiments (for example, the wireless network shown in FIG. 9). As shown, the network node 40 implements various functional means, units, or modules, e.g., via the processing circuitry 32 in FIG. 7 and/or via software code. These functional means, units, or modules, e.g., for implementing the method 200 herein, include for instance: operational scenario configuring unit 42 and K and/or S providing unit 44.

The operational scenario configuring unit 42 is configured to configure the wireless device with information related to at least one operational scenario for which relaxed RLP is allowed. The K and/or S providing unit 44 is configured to provide the wireless device at least one of a measurement relaxation factor K, a signal quality threshold S, a relation between K and an effective RS occasion periodicity Te, and a relation between S and an effective RS occasion periodicity Te.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

### Terminology

In some embodiments a more general term “network node” is used and it can correspond to any type of radio network node or any network node, which communicates with a UE and/or with another network node. Examples of network nodes are radio network node, gNodeB (gNB), ng-eNB, base station (BS), NR base station, TRP (transmission reception point), multi-standard radio (MSR) radio node such as MSR BS, network controller, radio network controller (RNC), base station controller (BSC), relay, access point (AP), transmission points, transmission nodes, RRU, RRH, nodes in distributed antenna system (DAS), core network node (e.g. MSC, MME, etc), O&M, OSS, SON, positioning node or location server (e.g. E-SMLC), MDT, test equipment (physical node or software), etc.

In some embodiments the non-limiting term user equipment (UE) or wireless device is used, and it refers to any type of wireless device communicating with a network node and/or with another UE in a cellular or mobile communication system. Examples of UE are wireless device supporting NR, target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), drone, Universal Serial Bus (USB) dongles, ProSe UE, Vehicle-to-vehicle (V2V) UE, Vehicle-to-anything (V2X) UE, etc.

The term “radio node” may refer to radio network node or UE capable of transmitting radio signals or receiving radio signals, or both.

The term radio access technology, or RAT, may refer to any RAT, e.g., UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The UE performs measurements on reference signal (RS). Examples of RS are discovery signal or discovery reference signal (DRS), SSB, CSI-RS, CRS, DMRS, PSS, SSS etc. Examples of measurements are cell identification (e.g., PCI acquisition, cell detection), Reference Symbol Received Power (RSRP), Reference Symbol Received Quality (RSRQ), secondary synchronization RSRP (SS-RSRP), SS-RSRQ, SINR, RS-SINR, SS-SINR, CSI-RSRP, CSI-RSRQ, acquisition of system information (SI), cell global ID (CGI) acquisition, Reference Signal Time Difference (RSTD), UE RX-TX time difference measurement, radio link quality, Radio Link Monitoring (RLM), which consists of Out of Synchronization (out of sync) detection and In Synchronization (in-sync) detection, Layer-1 RSRP (L1-RSRP), Layer-1 SINR (L1-SINR) etc. Each SSB carries NR-PSS, NR-SSS and NR-PBCH in 4 successive symbols. One or multiple SSBs are transmitted in one SSB burst which is repeated with certain periodicity, e.g., 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset wrt reference time (e.g., serving cell's SFN) etc. Therefore, SMTC occasion may also occur with certain periodicity, e.g., 5 ms, 10 ms, 20 ms, 40 ms, 80 ms and 160 ms.

The term radio link procedure (RLP) used herein may refer to any procedure performed by the UE on radio signals operating between UE and a cell, e.g., between UE and SpCell, between UE and SCell, etc. In one example, RLPs may differ based on their functionality or purpose. In another example, RLPs may differ based on the type of reference signal used by the RLP, e.g., SSB, CSI-RS etc. Examples of RLP performing different functions are RLM, BM, one or more procedures related to RLM (e.g., out of sync and/or in-sync evaluation, radio link failure detection), one or more procedures related to BM (e.g., BFD, CBD, L1-RSRP reporting, L1-SINR reporting etc), etc. Another set of examples of RLPs using different RS are RLM based on SSB, RLM based on CSI-RS, RLM based on both SSB and CSI-RS etc. Another set of examples of RLPs using different RS are BM on based on SSB, BM based on CSI-RS etc.

The term “relaxed mode” or “relaxed operational mode” is used herein to refer to performing certain RLP, which is associated with one or more relaxed requirements, compared to those associated with the normal mode of operation of the RLP. The normal mode (NM) is interchangeably called as legacy mode, mode without any relaxation etc. The corresponding requirements associated with NM are also called as reference requirements, legacy requirements, normal requirements etc. Examples of requirements are measurement time, measurement accuracy, measurement reporting periodicity, measurement, etc. Examples of measurement time are evaluation period or measurement period, e.g., L1 measurement period, L1-RSRP measurement period, L1-SINR measurement period, OOS evaluation period, IS evaluation period, BFD evaluation period, BFD evaluation period, L1 indication interval, IS indication interval, OOS indication interval, BFD indication interval etc. Examples of measurement accuracy are L1-RSRP accuracy (e.g., within ±X1 dB with respect to reference L1-RSRP value), L1-SINR accuracy (e.g., within ±X2 dB with respect to reference L1-SINR value).

The term measurement scaling factor used herein may also be called measurement relaxation factor, relaxation factor, measurement scaling factor, etc.

The term time resource used herein may correspond to any type of physical resource or radio resource expressed in terms of length of time. Examples of time resources include: symbol, time slot, subframe, radio frame, Transmission Time Interval (TTI), interleaving time, slot, sub-slot, mini-slot, etc.

### Network Scenario

Embodiments described herein may occur in a scenario comprising at least one UE (UE1) which is operating in a first cell (cell1) served by a network node (NW1). The UE may also be served by cell1. The UE may further be served by one or more additional cells (e.g., a second cell (cell2), a third cell (cell3), etc.) in multicarrier scenarios (MC) such as in carrier aggregation (CA), multi-connectivity (MuC), dual connectivity (DC), etc. DC comprises two cell groups: MCG served or managed by PCell and SCG served or managed by PSCell. MCG and SCG may also contain one or more SCells. Examples of DC are EN-DC, NE-DC, NR-DC, multi-RAT DC (MR-DC) etc. In MC operation the UE may be configured to perform one or more radio link procedures in one or more serving cells (e.g., cell1, cell2, cell3, etc), based on one or more reference signals (RS) transmitted by the respective cells. Examples of serving cells are SCells, SpCells, etc. Examples of SpCell are PCell and PSCell. Examples of radio link procedures carried out by the UE are RLM and BM which are described above. Examples of RS used by the UE for performing the RLPs are SSBs, CSI-RS, a mix of SSBs and CSI-RS, and other examples of RSs are also described above.

Each periodic occurrence of a reference signal, or the occurrence when the UE can operate a reference signal, is broadly referred to as an occasion. The occasion may be a DL occasion or an UL occasion. The term operating a signal or RS refers to UE receiving a signal or RS and/or UE transmitting a signal or RS in a cell. The occasion is also interchangeably called as signal occasion, reference signal (RS) occasion, signal operational occasion, RS operational occasion, measurement occasion, etc. The term effective occasion as used herein refers to an occasion at which the UE may actually operate or be able to operate a signal, e.g., due to DRX, measurement gap configuration, limited UE processing capability, etc. The effective occasion may also be called as effective signal occasion, effective RS occasion, effective signal operational occasion, effective RS operational occasion, effective measurement occasion, etc. The periodicity of the occasion of the signal or RS is denoted as T. The periodicity of the effective occasion of the signal or RS is denoted as Te where Te≥T. For consistency, the terms effective RS occasion and effective RS occasion periodicity (Te) are used hereinafter. For example, assume that in cell1 the SSB is configured with SSB periodicity (Tssb) of 40 ms, i.e., T=40 ms. But the UE can measure SSB only once every 80 ms, e.g., to save its power, or when configured in DRX with DRX cycle=80 ms or when configured with measurement gaps with DRX measurement gap periodicity=80 ms, or due to limited UE processing capability where UE must share its receiver for multiple receptions, etc. In this example Te=80 ms, i.e., Te=2*Tssb=2T.

Examples of periodic signals in the UL include but are not limited to SRS transmission, random access (RA) transmission, etc. RA is also referred to as PRACH or RACH, etc. The corresponding transmission occasion for sounding reference signal (SRS) transmission is called SRS transmission occasion or simply SRS occasion and corresponding transmission occasion for RA transmission is called as RA transmission occasion or simply RA occasion. Examples of periodic signals transmitted by a network node in the DL include, but not limited to, RS, DRS, SSB, CSI-RS, synchronization signals (SS), system information (SI), PBCH, SIB1, paging channel, etc. The corresponding reception occasions for RS, DRS, SS, SI, paging, SSB and CSI-RS are called as RS, DRS, SS, SI, paging, SSB or SMTC and CSI-RS reception occasions, respectively.

### EMBODIMENTS

Three main embodiments are described, which are elaborated below:

Embodiment #1: Methods in the UE for determining and applying measurement relaxation factor for performing RLPs in a relaxed mode.

Embodiment #2: Methods in the UE for determining and applying minimum signal quality thresholds for performing RLPs in a relaxed mode.

Embodiment #3: Methods in the UE for determining and applying measurement relaxation factor and signal quality thresholds for performing RLPs in a relaxed mode.

### Embodiment #1: Methods in the UE for Determining and Applying Measurement Relaxation Factor for Performing RLPs in a Relaxed Mode

The main steps involved in the UE can be summarized as below.
Step 1: UE determining whether it is operating in a scenario where relaxation of RLP is allowed;
Step 2: UE determining a measurement relaxation factor (K) based on an effective RS occasion periodicity (Te) for performing the RLP; and
Step 3: UE applying the determined measurement relaxation factor for performing the RLP.

These steps are described in detail below.

Step 1: UE Determining Whether it is Operating in a Scenario where Relaxation of RLPs is Allowed

In this step, the UE obtains information whether it is operating in a scenario where relaxation of RLP is allowed or not. The UE may obtain this information based on one or more rules, which may be pre-defined and/or configured by the network node.

The operational scenario where the relaxation of the RLP is allowed is characterized by one or more of the following:

Low mobility, (e.g., stationary UEs, UE speed below a certain threshold, Doppler frequency below a certain threshold, etc.). One example of an operational scenario under which the UE is allowed to perform relaxed RLP is based on the mobility state of the UE. For example, if the UE is in a low mobility state, then the UE is allowed to perform the RLPs following relaxed requirements compared to legacy requirements. The term low mobility or state of low mobility implies that the UE is stationary or moving at a speed below certain speed threshold, which can be pre-defined or configured by the network node. One set of examples of parameters defining UE speed comprises Doppler speed (e.g., X1 Hz, speed expressed in distance per unit time (e.g., X2 km/hour), etc. In this case as an example the UE speed is determined by measuring or estimating the UE speed based on any one or more speed related parameters. In another example, low mobility criterion is met when received signal level (e.g., RSRP) at the UE with respect to the cell is static or quasi-static over certain time period (Ts); otherwise, the low mobility criterion is not met. The received signal with respect to the cell is static or quasi-static if it does not change by more than certain margin (e.g., X1 dB) over certain time period (Ts); otherwise, the received signal level is not considered to be static or quasi-static. In this case, as an example, the UE speed is determined by measuring or estimating changes in the UE received signal level over Ts. In one example, the UE autonomously determines whether the UE is operating in low mobility or not. In another example, the network node determines whether the UE is operating in low mobility or not, e.g., based on UE reported measurements, measurement on UE signals at the base station, UE Doppler speed, etc. In one case the network node informs the UE whether the UE is operating in low mobility or not, i.e., whether the UE is meeting low mobility criterion or not. The UE therefore obtains information related to UE mobility, which indicates whether it is a mobile or stationary UE, and UE speed if it is mobile. The UE performs RLP in relaxed mode in a cell if the UE meets low mobility criterion in that cell; otherwise, the UE is not allowed to perform the RLPs in relaxed mode in that cell.

Low UE activity. UE activity level comprises the DRX cycle configuration, from which the network knows how frequently the UE is expected to be awake, how long the UE is going to be awake and its active time, etc. For example, certain types of UEs (e.g., IoT, RedCap type of devices) may be configured with long DRX cycles, allowing them to sleep for longer times and save battery life, while other type of UEs can be configured to wake up more frequently (e.g., handheld devices). If the DRX cycle length is below a certain threshold (e.g., below 640 ms), it is assumed that UE is allowed to perform relaxed RLP, since power saving is beneficial in such configuration compared to when the DRX cycle length configured in the UE is greater than that threshold. One generic example is shown in Table 1 below:

TABLE 1
Use of DRX cycle length for determining
whether relaxed RLP are allowed

| DRX cycle lengths | Allow relaxed RLPs |
|---|---|
| DRX cycle < Ha1 | Yes |
| DRX cycle length ≥ Ha1 | No |

A specific example is shown in Table 2 below:

TABLE 2
Use of DRX cycle length for determining
whether relaxed RLPs are allowed

| DRX cycle lengths | Allow relaxed RLPs |
|---|---|
| DRX cycle < 320 ms | Yes |
| DRX cycle length ≥ 320 ms | No |

Signal quality level for RLP. The UE may further be configured with a signal quality threshold (S) for comparing the measured or estimated signal quality or radio link quality (Qm) for RLP with S for determining whether to perform RLP in relaxed mode or not. The parameter S can be absolute threshold (Sa) or it can be relative threshold (Sr). Sa is used by the UE for comparing the signal quality directly with Sa for deciding whether to apply RLP in relaxed mode or not. Sr is used by the UE for comparing relation between signal quality (Qm) and a reference signal quality (Qr) with Sr for deciding whether to apply RLP in relaxed mode or not. In one example, Qr may correspond to function of signal quality (Q0) when no relaxation is applied to RLP and a certain margin (qm), e.g., Qr=Q0−qm. In another example, Qr may correspond to signal quality when no relaxation is applied to RLP. For example, when Sa is used, even if the UE meets low mobility criterion, the UE may be allowed to perform the RLP in relaxed mode provided that the signal quality (Qm) is above Sa; otherwise, the UE may not be allowed to perform RLM in relaxed mode. For example, when Sr is used, even if the UE meets low mobility criterion, the UE may be allowed to perform the RLP in relaxed mode provided that the difference between Qm and Qr is above Sr (e.g., (Qm−Qr)>Sr); otherwise, the UE may not be allowed to perform RLM in relaxed mode. The UE may perform signal quality for the RLP on certain RS (e.g., SSB, CSI-RS etc.) periodically, e.g., to assess the radio link quality. Examples of signal quality are SNR, SINR, RSRQ, etc

When low mobility criteria are met, the UE determines a signal quality threshold (S) above which the UE is allowed to perform the RLP over effective evaluation period (Tme).

The UE is allowed to perform RLP in a relaxed mode when it has fulfilled conditions for low mobility and/or UE activity level (e.g., DRX cycle is below threshold) and/or when the signal quality is above threshold, S.

When performing RLP with relaxation or performing RLP in relaxed mode, the UE is allowed to meet one or more relaxed RLP requirements compared to the corresponding legacy or reference RLP requirements. Examples of requirements are RLP measurement time. Examples of RLP measurement time are RLP evaluation period (e.g., OOS evaluation period, IS evaluation period, BFD evaluation period, CBD evaluation period, etc.), RLP measurement reporting delay (e.g., L1-RSRP reporting delay), RLP measurement accuracy (e.g., L1-RSRP accuracy, etc.), etc. For example, relaxed measurement time (Tmr) for certain RLP is longer than the corresponding legacy measurement time (Tm); Tmr>Tm. For example, legacy OOS evaluation period=800 ms, where OOS evaluation period in relaxed mode is 1600 ms, in this case it is assumed that K=2. The relaxed measurement time may also be called the effective measurement time.

### Step 2: Determining a Measurement Relaxation Factor (K) for Performing Relaxed RLP

In this second step, the UE determines at least one measurement scaling factor based on a parameter Te which is the effective RS occasion periodicity of a reference signal that is used for RLP. RLM is one specific example of RLP, it can be performed based on the reference signal SSB or CSI-RS. If SSB based measurements are used for RLM evaluations, then the parameter Te depends on the periodicity of SSB, which can vary from 5 ms to 160 ms. Similarly, if CSI-RS based measurements are used for RLM evaluations, then the parameter Te depends on the configured CSI-RS periodicity. However, the UE does not typically expect to use or receive the RSs in all transmitted occasions. Instead, how often or which occasions the UE is receiving the RS may depend on, e.g., DRX configuration. The effective RS periodicity is referred to the RSs occasions that the UE is expected to receive for performing RLPs, and not the transmitted RS occasions. Te can therefore depend on different parameters which comprises at least:
The periodicity of RS (Trs) of the RS configured for the RLP such as Tssb and Tcsi-rs,
DRX configuration with which the UE is configured, e.g., DRX cycle length (Tdrx)
Measurement gap sharing factor (P) for sharing the gap between RLP and RRM or between different types of RLPs,
one or more parameters (N) that is related to operated frequency range or margins (a) associated with the RLP.
etc.

The relation between the scaling factor K and Te can be expressed using a function:

$$K = f ( Te ) \qquad ( 1 )$$

The parameter K and/or relation between K and Te can be pre-defined or configured by the network node, e.g., via RRC, MAC, DCI signaling.

The effective RS occasion periodicity (Te) is expressed using a function:

$$Te = f 1 ( Trs , Tdrx , α , P , N ) \qquad ( 2 )$$

where: α=margin which depends on RLP e.g. α=1.5 for RLM.
P is measurement gap sharing factor for sharing the gap between RLP and a measurement (e.g., measurement for mobility, positioning etc) or between RLPs etc. P≤1.
N is s scaling factor which depends on operating frequency range (FR), e.g.,
   N=1 for FR1, e.g., for frequency below 7 GHz or between 410 MHz and 7 GHz,
   N=8 for FR2, e.g., for frequency above 24 GHz or between 24 GHz and 52.6 GHz.

Examples of how Te can be expressed or derived using the combinations of the one or more parameters Trs, Tdrx, α, P, N are given below.

In one example, Te depends only on Trs:

$$Te = Trs \qquad ( 3 )$$

where one specific example of Trs=Tssb (SSB periodicity); another specific example of Trs=Tcsi-rs (CSI-RS periodicity); another example of Trs=Tsmtc (SMTC occasion periodicity).

In another example, Te depends only on Tdrx and Trs:

$$Te = f 2 ( Tdrx , Trs ) \qquad ( 4 )$$

where one specific example of Te is Te=MAX(Tdrx, Trs).

In another example, Te depends only on Tdrx, Trs and P:

$$Te = f 3 ( f 4 ( α , P ) , f 2 ( Tdrx , Trs ) ) \qquad ( 5 )$$

where one specific example of Te is Te=CEIL(α*P)*MAX(Tdrx,Trs)

$$Te = f 5 ( f 4 ( α , P , N ) , f 2 ( Tdrx , Trs ) ) \qquad ( 6 )$$

where one specific example of Te is Te=CEIL(α*P*N)*MAX(Tdrx,Trs)
where the operation MAX(A, B) returns A if A>B, and otherwise returns B; and where CEIL(X) returns the smallest integer not less than X.

Examples of any of the above functions (f, f1, f2, f3, f4, f5, etc.) are maximum, minimum, ceiling, floor, average, sum, xth percentile, etc.

A general example showing the relation between the Te and the scaling factor is shown in Table 3 below. In this example as special case when Te>Hm−1 then K=km=1, which means no relaxation to RLP is allowed i.e., when Te>Hm−1

TABLE 3
General example showing the relation between the effective
RS periodicity and scaling factor assuming (m-1) thresholds

| | Relation between Te | |
|---|---|---|
| Case | and (m-1) thresholds | Scaling factor (K) |
| 1 | Te ≤ H1 | k1 |
| 2 | H1 < Te ≤ H2 | k2 |
| . . . | | |
| M | Te > Hm-1 | km |

Where: H1 < H2 < . . . < Hm-1; k1 > k2 > . . . > km

In one specific example assuming one threshold for Te, the K can be derived as follows:
If Te≤H then K=k1;
Else if Te>H then K=k2,
where k1 and k2 are different and related by a function, e.g., k1=f2(n1, k2). In one specific example k1>k2. In another example k1=n1*k2; where n1≥1.

In another specific example assuming 5 thresholds (H1=20 ms, H2=40 ms, H3=80 ms, H4=160 ms and H5=320 ms) for Te, the K can be derived as shown in Table 4. In this example when Te>320 ms then K5=K6=1, which means no relaxation to RLP is allowed, i.e., when Te>320 ms.

TABLE 4
Specific example showing the relation between
the effective RS periodicity and scaling factor

| Case | Relation between Te and 5 thresholds | Scaling factor (K) |
|---|---|---|
| 1 | Te ≤ 20 ms | k1 |
| 2 | 20 ms < Te ≤ 40 ms | k2 |
| 3 | 40 ms < Te ≤ 80 ms | k3 |
| 4 | 80 ms < Te ≤ 160 ms | k4 |
| 5 | 160 ms < Te ≤ 320 ms | k5 |
| 6 | Te > 320 ms | k6 |

Where: k1 > k2 > . . . > km; in specific example: k1 = 8, k2 = 4, k3 = 3, k4 = 2, k5 = 1, k6 = 1

In another specific example assuming 1 threshold (H=40 ms) for Te, the K can be derived as follows:
If Te≤40 ms then K=k1;
Else if Te>40 ms then K=k2,
where a specific example of k1=8 and k2=2.

### Determining of Scaling Factor Based on Effective RS Occasion Periodicity and Frequency Characteristics of the Operated Cell

In another exemplary embodiment, the UE may determine the scaling factor based both the effective reference signal occasion periodicity (Te) as described above, and the frequency characteristics of the cell where the RLP is operated. Examples of the frequency characteristics comprise: the frequency range (FR) of the resources over which the RLPs are performed (e.g., if RLM-RS, BM-RS, etc., are performed on a cell belonging to FR1, FR2, etc.), if the said resources are configured over carrier frequencies below certain frequency threshold(s) (Hf) or between certain frequency thresholds (Hf1 and Hf2).

In one example, if the UE is configured to perform one or more RLPs (e.g., RLM and BM) on a cell operating on a carrier belonging to a certain FR (e.g., FR1 or FR2) and the effective RS periodicity belongs to certain range (e.g., below a certain threshold), then the UE applies a certain value (e.g., K11) as the scaling factor. Otherwise, the UE applies a different scaling factor (e.g., K12). Examples of FR1 comprising frequencies between 400 MHz and 7 GHz, and of FR2 comprising frequencies between 24 GHz and 52.6 GHz.

A general example showing the relation between Te, frequency characteristics of the cell where RLP is operated and the scaling factor is shown in Table 5 below assuming m−1 thresholds:

TABLE 5
General example showing the relation between Te, FR and K

| | |
|---|---|
| Relation between Te | Scaling factor (K) |

| Case | and (m-1) thresholds | FR1 | FR2 |
|---|---|---|---|
| 1 | Te ≤ H1 | k11 | k12 |
| 2 | H1 < Te ≤ H2 | k21 | k22 |
| . . . | . . . | . . . | . . . |
| m | Te > Hm-1 | km1 | Km2 |

Where: (H1 < H2 < . . . < Hm-1); Ki1 = (k11 > k21 > . . . > km1); Ki2 = (k12 > k22 > . . . > km2)

Where: Ki1 and ki2 are related by a function: Ki1=f6(n2, Ki2). n2>1. As an example, Ki1=n2*Ki2; in another example Ki1>Ki2.

A specific example assuming 1 threshold for Te, the K can be derived as function of Te and FR as follows:
If Te≤40 then K=k11 for FR1 and K12 for FR2,
Else if Te>40 then K=k21 for FR1 and K22 for FR2
Specific example of K for FR1 are: k11=8 and k21=4
Specific example of K for FR2 are: k12=4 and k22=2

### Step 3: UE Applying the Determined Thresholds for Performing the RLP

In this step, when the UE meets criteria to perform RLP in relaxed mode (e.g., meets low mobility criterion), then the UE uses the determined scaling factor for performing the RLP, comprising one or more of the following:

Operating the RLP in a certain relaxed mode (e.g., low mobility) while meeting the one or more UE requirements for that RLP associated with that relaxed mode. For example, if the UE is allowed to operate the RLP in a relaxed mode, then the UE evaluates the RLPs over an effective measurement time or evaluation period (Tmr) instead of the legacy measurement time or evaluation period (Tm), where the Tmr>Tm. The relation between Tmr and Tm can be expressed using a function as follows:

$$Tmr = f 6 ( K , Tm ) \qquad ( 7 )$$

Examples of any of the functions are maximum, minimum, ceiling, floor, average, sum, xth percentile, etc.

A specific example of the function, f6, is given below:

$$Tmr = K * Tm \qquad ( 8 )$$

The UE may further use the determined scaling factor for reporting results of the RLP, e.g., L1-RSRP etc. When the scaling factor is applied, the reporting occurs less frequently, as compared to the case when the UE performs RLP in the normal mode where the scaling factor is not applied. The reporting herein comprises reporting to a third node, but also reporting internally to higher layers.

The embodiment is further described with specific examples for RLP=RLM and RLP=BM:

### Example 1: RLP is RLM

In this example:
the evaluation periods for OOS and IS when the UE is not performing the RLM in relaxed mode is shown in Table 6.
the evaluation periods for OOS and IS when the UE is performing the RLM in relaxed mode is shown in Table 7.
The OOS and IS evaluation periods in Table 7 are extended by scaling factors K1 and K2, respectively. In this example Te=Max(T_{DRX}, T_{SSB}), where K1 and K2 depend on Te.

TABLE 6
Radio link monitoring evaluation periods
when the UE is NOT allowed to relaxed RLM

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | Max(200, Ceil(10 × P) × T_{SSB}) | Max(100, Ceil(5 × P) × T_{SSB}) |
| DRX cycle ≤ 320 ms | Max(200, Ceil(1.5 × 10 × | Max(100, Ceil(1.5 × 5 × |
| | P) × Max(T_{DRX}, T_{SSB})) | P) × Max(T_{DRX}, T_{SSB})) |
| DRX cycle > 320 ms | Ceil(10 × P) × T_{DRX} | Ceil(5 × P) × T_{DRX} |

NOTE 1:
T_{SSB} is the periodicity of the SSB configured for RLM. T_{DRX} is the DRX cycle length.

TABLE 7
Radio link monitoring evaluation periods when the UE is allowed to relaxed RLM

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | Max(200, Ceil(10 × P) × T_{SSB}) | Max(100, Ceil(5 × P) × T_{SSB}) |
| DRX cycle ≤ 320 ms | Max(200, Ceil(Max(1.5, K1) × | Max(100, Ceil(Max(1.5, K2) × |
| | 10 × P) × Max(T_{DRX}, T_{SSB})) | 5 × P) × Max(T_{DRX}, T_{SSB})) |
| DRX cycle > 320 ms | Ceil(10 × P) × T_{DRX} | Ceil(5 × P) × T_{DRX} |

NOTE 1:
T_{SSB} is the periodicity of the SSB configured for RLM. T_{DRX} is the DRX cycle length.
NOTE 2:
K1 = 2 if Max(T_{DRX}, T_{SSB}) ≤ 20 ms, K1 = 1 if Max(T_{DRX}, T_{SSB}) > 20 ms
NOTE 3:
K2 = 8 if Max(T_{DRX}, T_{SSB}) ≤ 20 ms, K2 = 4 if Max(T_{DRX}, T_{SSB}) ≤ 40 ms, K2 = 2 if Max(T_{DRX}, T_{SSB}) ≤ 80 ms, K2 = 1 if Max(T_{DRX}, T_{SSB}) > 80 ms

### Example 2: RLP is BFD which is Part of BM Procedure

In this example:
the evaluation period for BFD when the UE is not performing the BFD in relaxed mode is shown in Table 8.
the evaluation period for BFD when the UE is performing the BFD in relaxed mode is shown in Table 9.
The BFD evaluation period in Table 8 is extended by scaling factor, K. In this example Te=Max(T_{DRX}, T_{SSB}), where K depends on Te.

TABLE 8
Beam failure detection evaluation period
when relaxed BFD is NOT allowed

| Configuration | T_{Evaluate}_{_{—}}_{BFD}_{_{—}}_{SSB} (ms) |
|---|---|
| no DRX | Max(50, Ceil(5 × P) × T_{SSB}) |
| DRX cycle ≤ 320 ms | Max(50, Ceil(1.5 × 5 × P) × Max(T_{DRX}, T_{SSB})) |
| DRX cycle > 320 ms | Ceil(5 × P) × T_{DRX} |

Note 1:
T_{SSB} is the periodicity of SSB in the set q̅₀. T_{DRX} is the DRX cycle length.

TABLE 9
Beam failure detection evaluation period when relaxed BFD is allowed

| Configuration | T_{Evaluate}_{_{—}}_{BFD}_{_{—}}_{SSB} (ms) |
|---|---|
| no DRX | Max(50, Ceil(5 × P) × T_{SSB}) |
| DRX cycle ≤ 320 ms | Max(50, Ceil(Max(1.5, K) × 5 × P) × Max(T_{DRX}, T_{SSB})) |
| DRX cycle > 320 ms | Ceil(5 × P) × T_{DRX} |

Note 1:
T_{SSB} is the periodicity of SSB in the set q̅₀. T_{DRX} is the DRX cycle length.
Note 2:
K = 8 if Max(T_{DRX}, T_{SSB}) ≤ 20 ms, K = 4 if Max(T_{DRX}, T_{SSB}) ≤ 40 ms, K = 2 if Max(T_{DRX}, T_{SSB}) ≤ 80 ms, K = 1 if Max(T_{DRX}, T_{SSB}) > 80 ms

### Embodiment #2: Methods in the UE for Determining and Applying Minimum Signal Quality Thresholds for Performing RLP in a Relaxed Mode

The main steps involved in the UE can be summarized as below.
Step 1: UE determining whether it is operating in a scenario where relaxation of RLP is allowed;
Step 2: UE determining a signal quality threshold (S) based on an effective RS occasion periodicity (Te) for performing RLP; and
Step 3: UE applying the determined signal quality threshold for performing the RLP.

These steps are described in detail below.

Step 1: UE Determining Whether it is Operating in a Scenario where Relaxation of RLP is Allowed

Step 1 described above for Embodiment #1 also applies here.

### Step 2: UE Determining a Minimum Signal Quality Threshold (S) Based on Te for Performing RLP

As stated above in one example the UE may apply the RLP in relaxed mode provided that the measured signal quality (Qm) is above certain absolute signal quality threshold (Sa) even if the UE meets criteria for relaxed mode (e.g., low mobility criteria). In another example the UE may apply the RLP in relaxed mode provided that the difference between Qm and reference signal quality (Qr) (e.g., Qm−Qr in dB) is above certain relative signal quality threshold (Sr) even if the UE meets criteria for relaxed mode (e.g., low mobility criteria). Therefore, the parameter S can be absolute threshold (Sa) or it can be relative threshold (Sr). For simplicity we use generic term, signal quality threshold, S, which may be Sa or Sr.

The parameters, Qr and S (Sa and/or Sr), may be pre-defined or configured by the network node.

In this step the UE determines parameter S which depends on Te and is related to Te as follows:

$$S = g ( Te ) \qquad ( 9 )$$

Te may be function of any one or more parameters (e.g., Trs, Tdrx, α, P, N, etc.) as described in embodiment #1 (step 2). Therefore, S may also be function of any one or more parameters (e.g., Trs, Tdrx, α, P, N, etc.) as described in embodiment #1.

The parameter S and/or relation between S and Te can be pre-defined or configured by the network node, e.g., via RRM, MAC, DCI signaling.

A general example to determine S based on Te assuming (m−1) thresholds (G1, G2, . . . , Gm−1) for Te, is shown in Table 10. As special case sm=infinity, which means no relaxation of RLP is allowed when Te>Gm−1 e.g. sm=infinity when Te>320 ms.

TABLE 10
An example of deriving S based on Te

| | Relation between Te and | Signal quality |
|---|---|---|
| Case | (m-1) thresholds (G) | threshold (S) |
| 1 | Te ≤ G1 | s1 |
| 2 | G1 < Te ≤ G2 | s2 |
| . . . | | |
| m | Te > Gm-1 | sm |

Where: G1 < G2 < . . . < Gm-1; s1 < s2 < . . . < sm

In one specific example assuming one threshold (G) for Te, the S can be derived as follows:
If Te≤G then S=s1;
Else if Te>G then S=s2
Where s1 and s2 are different and related by a function, e.g., s2=g1(m1, s1). In one specific example s1<s2. In another example s2=m1*s1; where m1≥1. As an example, s1=4 dB and s2=8 dB.

### Signal Quality Threshold (S) Depends on Te and FR

In yet another aspect of this embodiment, the S is function of an effective RS occasion periodicity (Te) of reference signal (RS) used for RLP and the frequency range (FR) of the RLP operation. The frequency range or frequency characteristics described in 5.3.2 also apply here. This is expressed by the following relation:

$$S = g 2 ( Te , FR ) \qquad ( 10 )$$

A general example of determining or deriving or obtaining S based on Te and FR assume (m−1) thresholds (G1, G2, . . . , Gm−1) for Te, is shown in table 11:

TABLE 11
An example of deriving S based on Te and FR

| | |
|---|---|
| Relation between Te and | Signal quality threshold (S) |

| Case | (m-1) thresholds (G) | FR1 | FR2 |
|---|---|---|---|
| 1 | Te ≤ G1 | s11 | s12 |
| 2 | G1 < Te ≤ G2 | s21 | s22 |
| . . . | . . . | . . . | . . . |
| m | Te > Gm-1 | sm1 | sm2 |

Where: (G1 < G2 < . . . < Gm-1); Si1 = (s11 < s21 < . . . < sm1); Si2 = (s12 < s22 < . . . < sm2)

Where: Si1 and Si2 are related by a function: Si2=g3(m2, Si1). m2≥1. As an example, Si2=m2*Si1; in another example Si1<Si2.

A specific example of determining or deriving or obtaining S based on Te and FR assuming 1 threshold (e.g. G=40 ms) for Te, is as follows:
If Te≤40 then S=s11 for FR1 and s12 for FR2;
Else if Te>40 then S=s21 for FR1 and s22 for FR2
Specific example of S for FR1 are: s11=4 dB and s21=6 dB
Specific example of S for FR2 are: s12=6 dB and s22=10 dB

### Step 3: UE Applying the Determined Thresholds for Performing the RLP

After determining or obtaining or deriving S as described in previous step, the UE uses the determined value of S to determine whether the UE can apply the relaxed RLP or not. If signal quality (Qm, e.g., SINRm) is above S (e.g., Sa) then the UE will apply the relaxed RLP otherwise the UE does not apply relaxed RLP. In another example if Qm compared to Qr (e.g., SINRm−SINRr) is above S (e.g., Sr) then the UE will apply the relaxed RLP otherwise the UE does not apply relaxed RLP. Where SINRm is measured SINR and SINRr is reference SINR.

When RLP is relaxed then UE uses effective measurement time, e.g., evaluation period (Tmr) for performing RLP. Otherwise, the UE uses legacy evaluation period (Tm) for performing RLP.

### Embodiment #3: Methods in the UE for Determining and Applying Measurement Relaxation Factor and Signal Quality Threshold Based on Te for Performing RLP in a Relaxed Mode

The main steps involved in the UE can be summarized as below.
Step 1: UE determining whether it is operating in a scenario where relaxation of RLP is allowed;
Step 2: UE determining a measurement relaxation factor (K) and a signal quality threshold (S) for performing RLP; and
Step 3: UE applying the determined measurement factor and minimum signal quality threshold(s) for performing the RLP.

These steps are described in detail below:

Step 1: UE Determining Whether it is Operating in a Scenario where Relaxation of RLPs is Allowed

Step 1 described above for Embodiments #1 and #2 also apply here.

### Step 2: UE Determining a Measurement Relaxation Factor (K) and Signal Quality Threshold (S) Based on Te for Performing RLP

In this step the UE determines, derives, or obtains both K and S based on Te for performing the RLP. This embodiment is therefore combination of the first and the second embodiments.

A general example to determine K and S based on Te assume (m−1) thresholds (P1, P2, . . . , Pm−1) for Te, is shown in table 12.

TABLE 12
An example of deriving K and S based on Te

| | Relation between Te and | Scaling | Signal quality |
|---|---|---|---|
| Case | (m-1) thresholds (G) | factor (K) | threshold (S) |
| 1 | Te ≤ G1 | k1 | s1 |
| 2 | G1 < Te ≤ G2 | k2 | s2 |
| . . . | | | |
| m | Te > Gm-1 | km | sm |

Where: (G1 < G2 < . . . < Gm-1); (k1 > k2 . . . > k3); (s1 < s2 < . . . < sm);

The number of scaling factors and number of signal quality thresholds may also be different for the same number of Te related thresholds. This is shown in another general example in table 13. The UE determines m scaling factors (k1, k2, . . . , km) and 2 signal quality thresholds (s1, and s2) based on Te assume (m−1) thresholds (P1, P2, . . . , Pm−1) for Te.

TABLE 13
An example of deriving K and S based on Te

| | Relation between Te and | Scaling | Signal quality |
|---|---|---|---|
| Case | (m-1) thresholds (G) | factor (K) | threshold (S) |
| 1 | Te ≤ G1 | k1 | s1 |
| 2 | G1 < Te ≤ G2 | k2 | |
| . . . | . . . | . . . | s2 |
| m | Te > Gm-1 | km | |

Where: (G1 < G2 < . . . < Gm-1); (k1 > k2 . . . > k3); (s1 < s2 < . . . < sm);

The UE may determine, derive or obtain both K and S based on Te and the FR for performing the RLP. This aspect of the embodiment is therefore combination of the first and the second embodiments where K and S depend on both Te and FR.

### Step 3: UE Applying the Determined Measurement Factor and Signal Quality Threshold for Performing the RLP

After determining or obtaining or deriving K and S as described in previous step, the UE uses the determined value of K and S as follows:
UE uses S to determine whether the UE can apply the relaxed RLP or not. In one example if the signal quality (e.g. SINR) measured or estimated for the RLP is above S (e.g. Sa) then the UE will apply the relaxed RLP; otherwise the UE does not apply relaxed RLP. In another example if the signal quality (e.g. SINR) measured or estimated for the RLP compared to reference signal quality is above Sr then the UE will apply the relaxed RLP; otherwise the UE does not apply relaxed RLP.
UE uses K to determine the effective measurement time (Tmr) for RLP (e.g. effective evaluation period of IS, OOS etc for RLM). In one example the UE determines Tmr provided that signal quality >S; otherwise the UE does not determine Tmr.

When RLP is relaxed then the UE uses Tmr for evaluation of the RLP. Otherwise, the UE uses legacy evaluation period (Tm) for performing RLP

### Network Description and Over the Top (OTT) Embodiments

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 1106, network nodes 1160 and 1160b, and wireless devices (WD) 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and WD 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 9 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

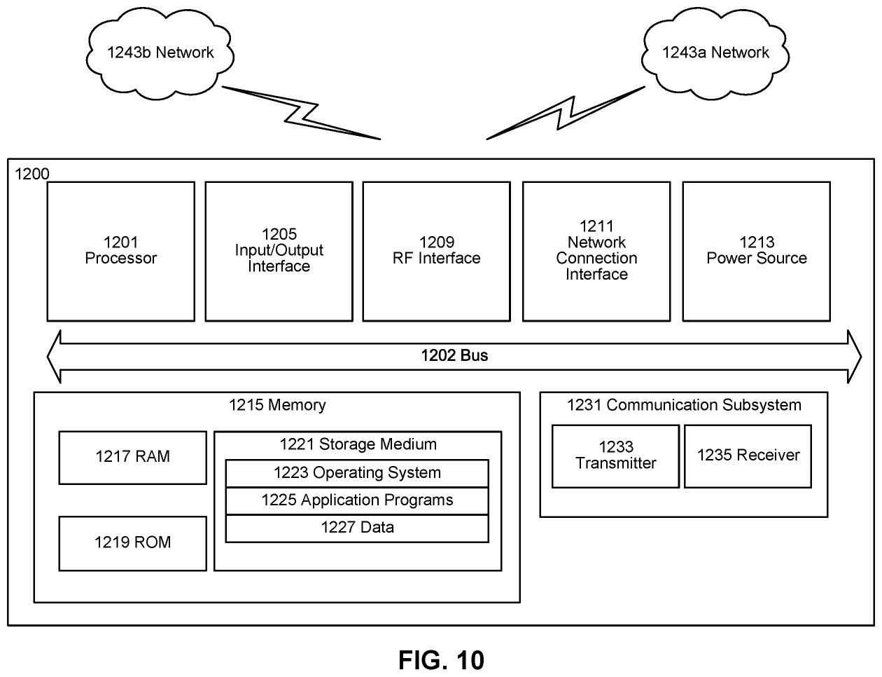

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1200 may be any UE identified by the 3rd Generation Partnership Project (3GPP), including a NB-IoT UE, a machine type communication (MTC) UE, and/or an enhanced MTC (eMTC) UE. UE 1200, as illustrated in FIG. 10, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 10, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.10, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software, or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software, or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

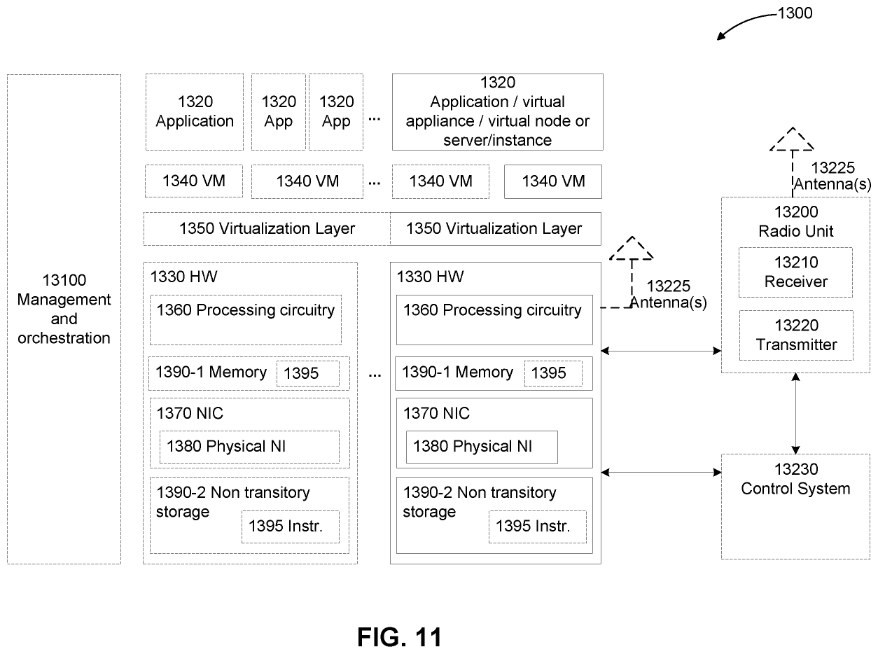

FIG. 11 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 11, hardware 1330 may be a standalone network node with generic or specific components. Hardware 1330 may comprise antenna 13225 and may implement some functions via virtualization. Alternatively, hardware 1330 may be part of a larger cluster of hardware (e.g., such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 11.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signalling can be effected with the use of control system 13230 which may alternatively be used for communication between the hardware nodes 1330 and radio units 13200.

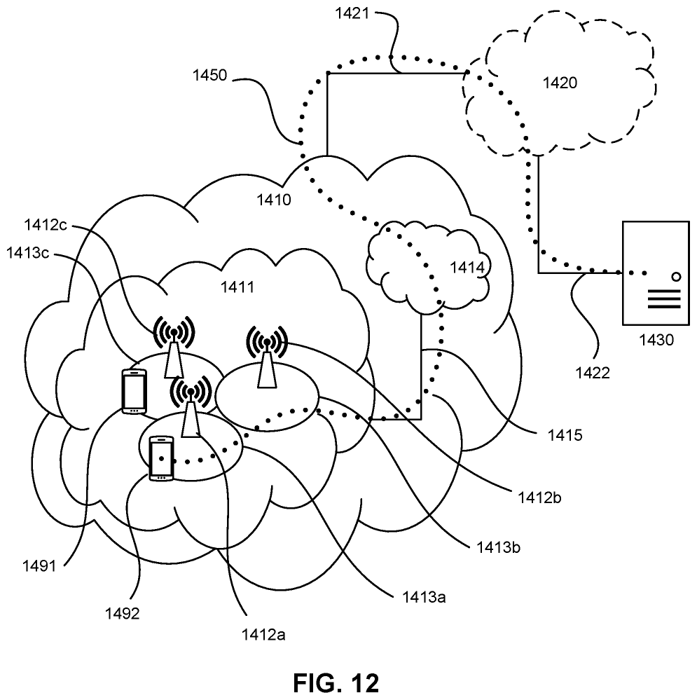

FIG. 12 illustrates a telecommunication network connected via an intermediate network to a host computer in accordance with some embodiments. In particular, with reference to FIG. 12, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 12 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

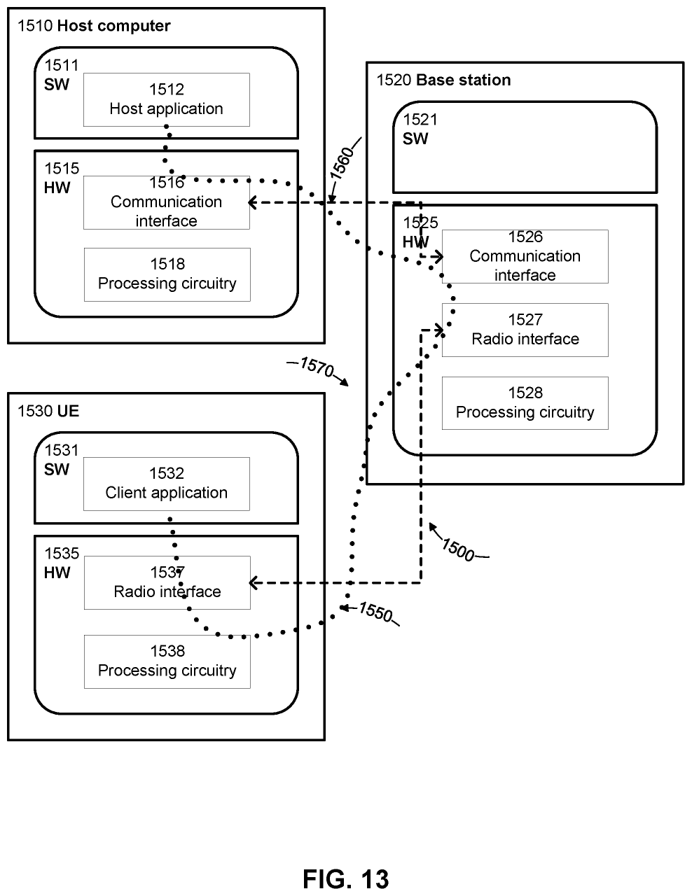

Example implementations, in accordance with an embodiment, of the UE, base station and host computer discussed in the preceding paragraphs will now be described with reference to FIG. 13. FIG. 13 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 13) served by base station 1520. Communication interface 1526 may be configured to facilitate connection 1560 to host computer 1510. Connection 1560 may be direct or it may pass through a core network (not shown in FIG. 13) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 13 may be similar or identical to host computer 1430, one of base stations 1412a, 1412b, 1412c and one of UEs 1491, 1492 of FIG. 12, respectively. This is to say, the inner workings of these entities may be as shown in FIG. 13 and independently, the surrounding network topology may be that of FIG. 12.

In FIG. 13, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve power consumption and thereby provide benefits such as extended battery life and hence an improved user experience.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

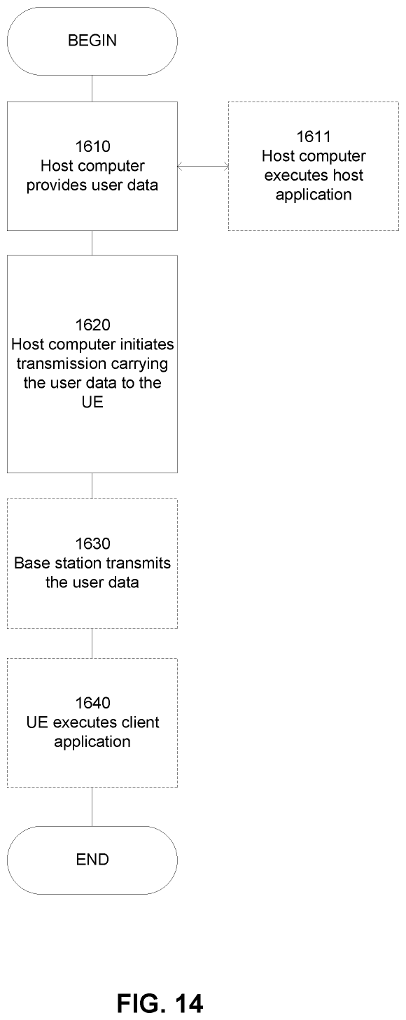

FIG. 14 is a flowchart illustrating a method implemented in a communication system, in accordance with one embodiment. The communication system includes a host computer, a base station and a UE which may be those described with reference to FIG. 12 and FIG. 13. For simplicity of the present disclosure, only drawing references to FIG. 14 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

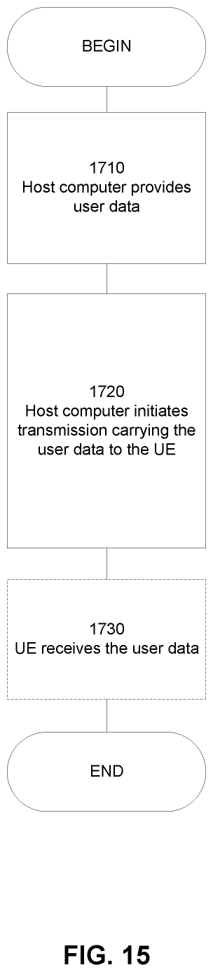

FIG. 15 is a flowchart illustrating a method implemented in a communication system, in accordance with one embodiment. The communication system includes a host computer, a base station and a UE which may be those described with reference to FIG. 12 and FIG. 13. For simplicity of the present disclosure, only drawing references to FIG. 15 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

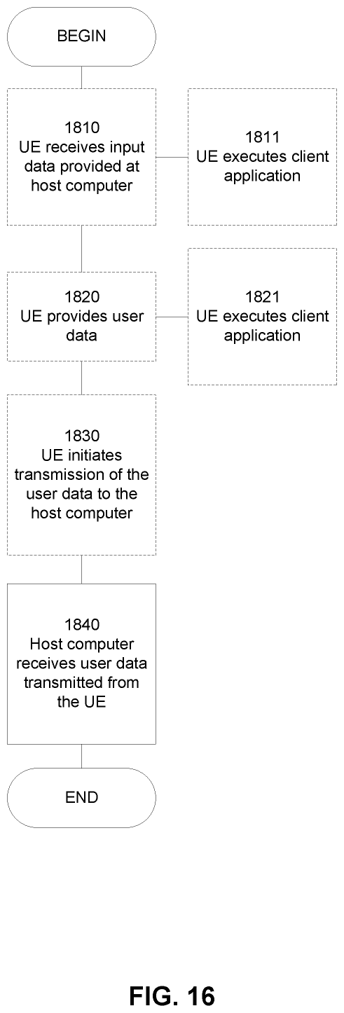

FIG. 16 is a flowchart illustrating a method implemented in a communication system, in accordance with one embodiment. The communication system includes a host computer, a base station and a UE which may be those described with reference to FIG. 12 and FIG. 13. For simplicity of the present disclosure, only drawing references to FIG. 16 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

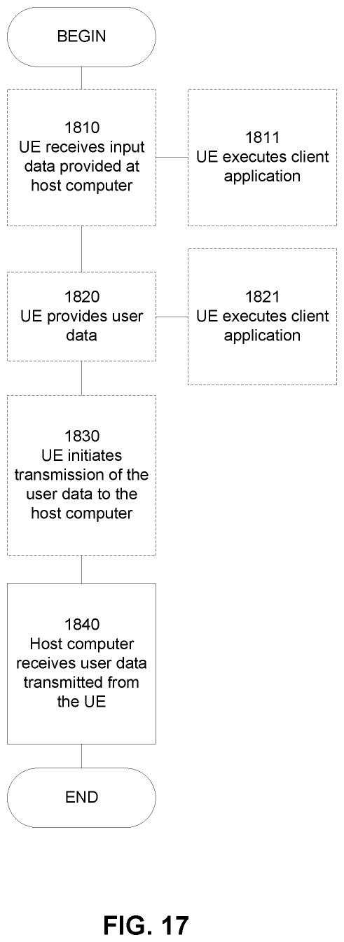

FIG. 17 is a flowchart illustrating a method implemented in a communication system, in accordance with one embodiment. The communication system includes a host computer, a base station and a UE which may be those described with reference to FIG. 12 and FIG. 13. For simplicity of the present disclosure, only drawing references to FIG. 17 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein. As used herein, the term “configured to” means set up, organized, adapted, or arranged to operate in a particular way; the term is synonymous with “designed to.” As used herein, the term “substantially” means nearly or essentially, but not necessarily completely; the term encompasses and accounts for mechanical or component value tolerances, measurement error, random variation, and similar sources of imprecision.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

### Representative Embodiments

### Group A Embodiments

1. A method (100) of performing Radio Link Procedures, RLP, performed by a wireless device (5, 10, 20) operative in a wireless communication network (1), the method (100) characterized by:
determining (102) whether the wireless device (5, 10, 20) is operating in an operational scenario for which relaxed RLP is allowed;
in response to determining relaxed RLP is allowed (104), determining (108) at least one of a measurement relaxation factor K and a signal quality threshold S based on an effective Reference Signal, RS, occasion periodicity Te; and applying (110) at least one of the determined measurement relaxation factor K and signal quality threshold S for performing the RLP.
2. The method (100) of embodiment 1, further comprising, in response to determining relaxed RLP is not allowed (104), and performing (106) RLP using a RS occasion periodicity T wherein T<Te.
3. The method (100) of embodiment 1, wherein relaxed RLP is allowed, and wherein the wireless device (5, 10, 20) determines only the measurement relaxation factor K and applies only the measurement relaxation factor K to the RLP.
4. The method (100) of embodiment 1, wherein relaxed RLP is allowed, and wherein the wireless device (5, 10, 20) determines only the signal quality threshold S and applies the only the signal quality threshold S to the RLP.
5. The method (100) of embodiment 1, wherein relaxed RLP is allowed, and wherein the wireless device (5, 10, 20) determines both the measurement relaxation factor K and the signal quality threshold S, and applies both the measurement relaxation factor K and the signal quality threshold S to the RLP.
6. The method (100) of any preceding embodiment, wherein operational scenarios for which relaxed RLP is allowed include one or more of low wireless device mobility; low wireless device activity; and signal quality above a threshold.
7. The method (100) of embodiment 6, wherein low wireless device mobility includes the wireless device (5, 10, 20) is stationary, and the wireless device (5, 10, 20) is moving at a speed below a predetermined threshold.
8. The method (100) of embodiment 6, wherein low wireless device activity includes the wireless device (5, 10, 20) is in Discontinuous Reception, DRX, operation.
9. The method (100) of any preceding embodiment, wherein determining (102) whether the wireless device (5, 10, 20) is operating in an operational scenario for which relaxed RLP is allowed comprises determining that the wireless device (5, 10, 20) is configured with an operational scenario and meeting a criterion associated with the configured operational scenario.
10. The method (100) of embodiment 1, wherein one or both of the measurement relaxation factor K and the signal quality threshold S are a function of the effective RS occasion periodicity Te.
11. The method (100) of embodiment 10, wherein one or both of the measurement relaxation factor K and the signal quality threshold S are further a function of frequency characteristics of the cell on which the mobile device (5, 10, 20) is operating.
12. The method (100) of any preceding embodiment, wherein the effective RS occasion periodicity Te depends on one or more of the periodicity of a RS, a Discontinuous Reception, DRX, configuration in the wireless device (5, 10, 20), a measurement gap sharing factor P, a scaling factor N that depends on a frequency range in which the wireless device (5, 10, 20) is operating, and a margin a associated with the RLP.
13. The method (100) of any of preceding embodiment, wherein the effective RS occasion periodicity Te is function of periodicity of a RS, and a Discontinuous Reception, DRX, configuration in the wireless device (5, 10, 20).
14. The method (100) of any preceding embodiment, wherein performing RLP using the effective RS occasion periodicity Te comprises performing the RLP over an effective measurement time Tmr, where Tmr is greater than a measurement time Tm used when relaxed RLP is not allowed.
15. The method (100) of embodiment 14, wherein Tmr is a function of K and Tm.
16. The method (100) of any preceding embodiment, wherein in response to determining relaxed RLP is not allowed (104), performing RLP over the measurement time Tm.
17. The method (100) of embodiment 1, wherein the signal quality threshold S is an absolute signal quality threshold Sa, and wherein the wireless device (5, 10, 20) performs RLP using the effective RS occasion periodicity Te if a measured signal quality Qm is greater than Sa.
18. The method (100) of embodiment 1, wherein the signal quality threshold S is a relative signal quality threshold Sr, and wherein the wireless device (5, 10, 20) performs RLP using the effective RS occasion periodicity Te if the difference between a measured signal quality Qm and a reference signal quality Qr is greater than Sr.
19. The method (100) of embodiment 5, and further comprising:
in response to a measured or estimated signal quality being greater than S, performing RLP by using K to determine an effective measurement time Tmr; and in response to the measured or estimated signal quality not being greater than S, performing RLP by using a measurement time Tm that is used when relaxed RLP is not allowed.
AA. The method of any of the previous embodiments, further comprising:
providing user data; and
forwarding the user data to a host computer via the transmission to the base station.

### Group B EMBODIMENTS

20. A method (200) of serving a wireless device (5, 10, 20) performing Radio Link Procedures, RLP, by a network node (4) operative in a wireless communication network (1), the method (200) characterized by:
configuring the wireless device with information related to at least one operational scenario for which relaxed RLP is allowed (202); and
providing the wireless device at least one of a measurement relaxation factor K, a signal quality threshold S, a relation between K and an effective RS occasion periodicity Te, and a relation between S and an effective RS occasion periodicity Te.
21. The method (200) of embodiment 20, wherein operational scenarios for which relaxed RLP is allowed include one or more of low wireless device mobility; low wireless device activity; and signal quality above a threshold.
22. The method (200) of embodiment 21, wherein low wireless device mobility includes the wireless device (5, 10, 20) is stationary and the wireless device (5, 10, 20) is moving at a speed below a predetermined threshold.
23. The method (200) of embodiment 21, wherein low wireless device activity includes the wireless device (5, 10, 20) is in Discontinuous Reception, DRX, operation.
24. The method (200) of any of embodiments 20-23, wherein the effective RS occasion periodicity Te depends on one or more of the periodicity of a relevant RS, a Discontinuous Reception, DRX, configuration in the wireless device (5, 10, 20), a measurement gap sharing factor P, a scaling factor N that depends on a frequency range in which the wireless device (5, 10, 20) is operating, and a margin a associated with the RLP.
25. The method (200) of any of embodiments 20-24, wherein receiving (206) RLP reports from the wireless device using the effective RS occasion periodicity Te comprises receiving the RLP reports over an effective measurement time Tmr, where Tmr is greater than a measurement time Tm used when relaxed RLP is not allowed.
BB. The method of any of the previous embodiments, further comprising:
obtaining user data; and forwarding the user data to a host computer or a wireless device.

### Group C Embodiments

C1. A wireless device configured to perform any of the steps of any of the Group A embodiments.
C2. A wireless device comprising:
   processing circuitry configured to perform any of the steps of any of the Group A embodiments; and
   power supply circuitry configured to supply power to the wireless device.
C3. A wireless device comprising:
   processing circuitry and memory, the memory containing instructions executable by the processing circuitry whereby the wireless device is configured to perform any of the steps of any of the Group A embodiments.
C4. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and a battery connected to the processing circuitry and configured to supply power to the UE.
C5. A computer program comprising instructions which, when executed by at least one processor of a wireless device, causes the wireless device to carry out the steps of any of the Group A embodiments.
C6. A carrier containing the computer program of embodiment C5, wherein the carrier is one of an electronic signal, optical signal, radio signal, or computer readable storage medium.
C7. A base station configured to perform any of the steps of any of the Group B embodiments.
C8. A base station comprising:
   processing circuitry configured to perform any of the steps of any of the Group B embodiments;
   power supply circuitry configured to supply power to the base station.
C9. A base station comprising:
   processing circuitry and memory, the memory containing instructions executable by the processing circuitry whereby the base station is configured to perform any of the steps of any of the Group B embodiments.
C10. A computer program comprising instructions which, when executed by at least one processor of a base station, causes the base station to carry out the steps of any of the Group B embodiments.
C11. A carrier containing the computer program of embodiment C10, wherein the carrier is one of an electronic signal, optical signal, radio signal, or computer readable storage medium.

### Group D Embodiments

D1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
D2. The communication system of the pervious embodiment further including the base station.
D3. The communication system of the previous 2 embodiments, further including the UE, wherein the UE is configured to communicate with the base station.
D4. The communication system of the previous 3 embodiments, wherein:
   the processing circuitry of the host computer is configured to execute a host application, thereby providing the user data; and
   the UE comprises processing circuitry configured to execute a client application associated with the host application.
D5. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
D6. The method of the previous embodiment, further comprising, at the base station, transmitting the user data.
D7. The method of the previous 2 embodiments, wherein the user data is provided at the host computer by executing a host application, the method further comprising, at the UE, executing a client application associated with the host application.
D8. A user equipment (UE) configured to communicate with a base station, the UE comprising a radio interface and processing circuitry configured to perform any of the previous 3 embodiments.
D9. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
D10. The communication system of the previous embodiment, wherein the cellular network further includes a base station configured to communicate with the UE.
D11. The communication system of the previous 2 embodiments, wherein:
   the processing circuitry of the host computer is configured to execute a host application, thereby providing the user data; and
   the UE's processing circuitry is configured to execute a client application associated with the host application.
D12. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
D13. The method of the previous embodiment, further comprising at the UE, receiving the user data from the base station.
D14. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
D15. The communication system of the previous embodiment, further including the UE.
D16. The communication system of the previous 2 embodiments, further including the base station, wherein the base station comprises a radio interface configured to communicate with the UE and a communication interface configured to forward to the host computer the user data carried by a transmission from the UE to the base station.
D17. The communication system of the previous 3 embodiments, wherein:
   the processing circuitry of the host computer is configured to execute a host application; and
   the UE's processing circuitry is configured to execute a client application associated with the host application, thereby providing the user data.
D18. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
D19. A method implemented in a communication system including a host computer, a base station and a user equipment (UE), the method comprising:
   at the host computer, receiving user data transmitted to the base station from the UE, wherein the UE performs any of the steps of any of the Group A embodiments.
D20. The method of the previous embodiment, further comprising, at the UE, providing the user data to the base station.
D21. The method of the previous 2 embodiments, further comprising:
   at the UE, executing a client application, thereby providing the user data to be transmitted; and
   at the host computer, executing a host application associated with the client application.
D22. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
D24. The communication system of the previous embodiment further including the base station.
D25. The communication system of the previous 2 embodiments, further including the UE, wherein the UE is configured to communicate with the base station.
D26. The communication system of the previous 3 embodiments, wherein:
   the processing circuitry of the host computer is configured to execute a host application;
   the UE is configured to execute a client application associated with the host application, thereby providing the user data to be received by the host computer.
D27. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
D28. The method of the previous embodiment, further comprising at the base station, receiving the user data from the UE.
D29. The method of the previous 2 embodiments, further comprising at the base station, initiating a transmission of the received user data to the host computer.

1-50. (canceled)

51. A method of performing Radio Link Procedures (RLP) performed by a wireless device operative in a wireless communication network, the method characterized by:
determining whether the wireless device is operating in an operational scenario for which relaxed RLP is allowed;
in response to determining relaxed RLP is allowed,
determining at least one of a measurement relaxation factor K and a signal quality threshold S based on an effective Reference Signal (RS) occasion periodicity Te; and
applying at least one of the determined measurement relaxation factor K and signal quality threshold S for performing the RLP.

52. The method of claim 51, further comprising, in response to determining relaxed RLP is not allowed, and performing RLP using a RS occasion periodicity T wherein T<Te.

53. The method of claim 51, wherein relaxed RLP is allowed, and wherein the wireless device determines only the measurement relaxation factor K and applies only the measurement relaxation factor K to the RLP.

54. The method of claim 51, wherein relaxed RLP is allowed, and wherein the wireless device determines only the signal quality threshold S and applies the only the signal quality threshold S to the RLP.

55. The method of claim 51, wherein relaxed RLP is allowed, and wherein the wireless device determines both the measurement relaxation factor K and the signal quality threshold S, and applies both the measurement relaxation factor K and the signal quality threshold S to the RLP.

56. The method of claim 51 wherein operational scenarios for which relaxed RLP is allowed include one or more of low wireless device mobility; low wireless device activity; and signal quality above a threshold.

57. The method of claim 56 wherein low wireless device mobility includes the wireless device is stationary, and the wireless device is moving at a speed below a predetermined threshold.

58. The method of claim 56 wherein low wireless device activity includes the wireless device is in Discontinuous Reception (DRX) operation.

59. The method of claim 51 wherein determining whether the wireless device is operating in an operational scenario for which relaxed RLP is allowed comprises determining that the wireless device is configured with an operational scenario and meeting a criterion associated with the configured operational scenario.

60. The method of claim 51 wherein one or both of the measurement relaxation factor K and the signal quality threshold S are a function of the effective RS occasion periodicity Te.

61. The method of claim 60 wherein one or both of the measurement relaxation factor K and the signal quality threshold S are further a function of frequency characteristics of the cell on which the mobile device is operating.

62. The method of claim 51 wherein the effective RS occasion periodicity Te depends on one or more of the periodicity of a RS, a Discontinuous Reception (DRX) configuration in the wireless device, a measurement gap sharing factor P, a scaling factor N that depends on a frequency range in which the wireless device is operating, and a margin a associated with the RLP.

63. The method of claim 51 wherein the effective RS occasion periodicity Te is function of periodicity of a RS, and a Discontinuous Reception (DRX) configuration in the wireless device.

64. The method of claim 51 wherein performing RLP using the effective RS occasion periodicity Te comprises performing the RLP over an effective measurement time Tmr, where Tmr is greater than a measurement time Tm used when relaxed RLP is not allowed.

65. The method of claim 64 wherein Tmr is a function of K and Tm.

66. The method of claim 51 wherein in response to determining relaxed RLP is not allowed, performing RLP over the measurement time Tm.

67. The method of claim 51 wherein the signal quality threshold S is an absolute signal quality threshold Sa, and wherein the wireless device performs RLP using the effective RS occasion periodicity Te if a measured signal quality Qm is greater than Sa.

68. The method of claim 51 wherein the signal quality threshold S is a relative signal quality threshold Sr, and wherein the wireless device performs RLP using the effective RS occasion periodicity Te if the difference between a measured signal quality Qm and a reference signal quality Qr is greater than Sr.

69. The method of claim 55, and further comprising:
in response to a measured or estimated signal quality being greater than S, performing RLP by using K to determine an effective measurement time Tmr; and
in response to the measured or estimated signal quality not being greater than S, performing RLP by using a measurement time Tm that is used when relaxed RLP is not allowed.

70. A method of serving a wireless device performing Radio Link Procedures (RLP) by a network node operative in a wireless communication network, the method characterized by:
configuring the wireless device with information related to at least one operational scenario for which relaxed RLP is allowed; and
providing the wireless device at least one of a measurement relaxation factor K, a signal quality threshold S, a relation between K and an effective RS occasion periodicity Te, and a relation between S and an effective RS occasion periodicity Te.
